(19) United States
(12) Patent Application Publication
(10) Pub. No.: US 2023/0051155 A1
(43) Pub. Date: Feb. 16, 2023

(54) SYSTEM AND METHOD FOR GENERATING LINEAR FEATURE DATA ASSOCIATED WITH ROAD LANES

(71) Applicant: HERE Global B.V., Eindhoven (NL)

(72) Inventor: Zhenhua ZHANG, Chicago, IL (US)

(21) Appl. No.: 17/402,174

(22) Filed: Aug. 13, 2021

(51) Int. Cl. G01C 21/34; G01C 21/00; G01C 21/30

(52) U.S. Cl. CPC G01C 21/3446; G01C 21/3815; G01C 21/30

(57) ABSTRACT

A system for generating linear feature data is provided. The system may determine, from sensor data, detection data associated with at least one link. The at least one link comprises a plurality of sub links. The system may further determine, using map data, one or more linear feature clusters for each of the plurality of sub links, based on the detection data. Furthermore, the system may determine a plurality of linear feature groups for the at least one link, based on at least one set of feature matched distances and the determined linear feature clusters, where a given linear feature group respectively comprises at least one first linear feature cluster associated with a first sub link and at least one second linear feature cluster associated with a second sub link. Furthermore, the system may generate the linear feature data, based on the plurality of linear feature groups.

### TECHNOLOGICAL FIELD

The present disclosure generally relates to routing and navigation systems, and more particularly relates to methods and systems for generating linear feature data in routing and navigation systems.

### BACKGROUND

Currently, various navigation systems are available for vehicle navigation. These navigation systems generally request navigation related data or map data thereof from a navigation service. The map data stored in the navigation service may be updated by using sensor data aggregated from various vehicles. The sensor data may include data about linear feature detections indicative of lane markings, guardrails, roadwork zones, roadwork extensions and the like on a route. The navigation systems based on such navigation related data may be used for vehicle navigation of autonomous, semi-autonomous, or manual vehicles.

Therefore, the sensor data should be accurate to help enable reliable vehicle navigation or the like. However, in many cases, the sensor data may not be accurate or reliable.

### BRIEF SUMMARY OF SOME EXAMPLE EMBODIMENTS

Generally, the sensor data that include the data about the linear feature detections may not be accurate, due to occlusions (caused by interference of other vehicles), noise in sensors, or other defects in the sensors. Hereinafter, the ‘data about the linear feature detections’ and ‘detection data’ may be interchangeably used to mean the same.

In order to solve the foregoing problem, a system, a method, and a computer program product are provided in accordance with an example embodiment for generating linear feature data.

In one aspect, a system for generating the linear feature data is disclosed. The system comprises a memory configured to store computer-executable instructions; and at least one processor configured to execute the computer-executable instructions to: determine, from sensor data, detection data associated with at least one link, wherein the at least one link comprises a plurality of sub links; determine, using map data, one or more linear feature clusters respectively for each of the plurality of sub links, based on the detection data, wherein the one or more linear feature clusters are associated with at least one set of feature matched distances, wherein the at least one set of feature matched distances comprises a respective feature matched distance for each linear feature cluster; determine a plurality of linear feature groups for the at least one link, based on the at least one set of feature matched distances and the determined one or more linear feature clusters, wherein a given linear feature group respectively comprises at least a first linear feature cluster associated with a first sub link and at least a second linear feature cluster associated with a second sub link; and generate the linear feature data, based on the determined plurality of linear feature groups.

In additional system embodiments, determining the plurality of linear feature groups comprises group the first linear feature cluster and the second linear feature cluster into a linear feature group, when a difference between (i) the respective feature matched distance of the first linear feature cluster and (ii) the respective feature matched distance of the second linear feature cluster is less than a threshold difference value.

In additional system embodiments, determining the one or more linear feature clusters for a sub link of the plurality of sub links comprises: identify, from the detection data, a plurality of linear feature points associated with the sub link; determine, using the map data, a matched distance for each of the plurality of linear feature points associated with the sub link; and determine a linear feature cluster for the sub link based on a clustering criteria, wherein the clustering criteria comprises the determined matched distance, and wherein each linear feature cluster of the one or more linear feature clusters of the sub link comprises one or more linear feature point with identical matched distances.

In additional system embodiments, the feature matched distance associated with the linear feature cluster of the one or more linear feature clusters is a weighted median of the corresponding matched distances associated with the linear feature cluster.

In additional system embodiments, the at least one processor is further configured to remove diagonal detection data from the detection data, wherein the diagonal detection data comprises at least two linear feature points, and wherein each of the at least two linear feature points is associated with a different linear feature cluster in the one or more linear feature clusters.

In additional system embodiments, the at least one processor is further configured to update the map data to include the generated linear feature data for the at least one link.

In additional system embodiments, the at least one processor is further configured to: determine a status of the detection data associated with the at least one link, wherein the status of the detection data comprises at least one of discontinuous detection data or continuous detection data; and determine the one or more linear feature clusters respectively for each of the plurality of sub links, in response to determining the status of the detection data is the discontinuous detection data.

In additional system embodiments, determining the detection data associated with the at least one link comprises: obtain the sensor data; map-match, using the map data, the sensor data to identify the at least one link; and determine, from the sensor data, the detection data associated with the identified at least one link.

In another aspect, a method for generating linear feature data is provided. The method includes: determining, from sensor data, detection data associated with at least one link, wherein the at least one link comprises a plurality of sub links; determining, using map data, one or more linear feature clusters respectively for each of the plurality of sub links, based on the detection data, wherein the one or more linear feature clusters are associated with at least one set of feature matched distances, wherein the at least one set of feature matched distances comprises a respective feature matched distance for each linear feature cluster; determining a plurality of linear feature groups for the at least one link, based on the at least one set of feature matched distances and the determined one or more linear feature clusters, wherein a given linear feature group respectively comprises at least a first linear feature cluster associated with a first sub link and at least a second linear feature cluster associated with a second sub link; and generating the linear feature data, based on the determined plurality of linear feature groups.

In additional method embodiments, determining the plurality of linear feature groups further comprises grouping the first linear feature cluster and the second linear feature cluster into a linear feature group, based on (i) the respective feature matched distance of the first linear feature cluster and (ii) the respective feature matched distance the second linear feature cluster substantially matching one another.

In additional method embodiments, determining the one or more linear feature clusters for a sub link of the plurality of sub links comprises: identifying, from the detection data, a plurality of linear feature points associated with the sub link; determining, using the map data, a matched distance for each of the plurality of linear feature points associated with the sub link; and determining a linear feature cluster for the sub link based on a clustering criteria, wherein the clustering criteria comprises the determined matched distance, and wherein each linear feature cluster of the one or more linear feature clusters of the sub link comprises one or more linear feature points with identical matched distances.

In additional method embodiments, the feature matched distance associated with the linear feature cluster of the one or more linear feature clusters is a weighted median of the corresponding matched distances associated with the linear feature cluster.

In additional method embodiments, the method further comprises removing diagonal detection data from the detection data, wherein the diagonal detection data comprises at least two linear feature points, and wherein each of the at least two linear feature points is associated with a different linear feature cluster in the one or more linear feature clusters.

In additional method embodiments, the method further comprises updating the map data to include the generated linear feature data for the at least one link.

In yet another aspect, a computer program product comprising a non-transitory computer readable medium having stored thereon computer executable instruction which when executed by at least one processor, cause the at least one processor to carry out operations for generating linear feature data, the operations comprising: determining, from sensor data, detection data associated with at least one link, wherein the at least one link comprises a plurality of sub links; determining, using map data, one or more linear feature clusters respectively for each of the plurality of sub links, based on the detection data, wherein the one or more linear feature clusters are associated with at least one set of feature matched distances, wherein the at least one set of feature matched distances comprises a respective feature matched distance for each linear feature cluster; determining a plurality of linear feature groups for the at least one link, based on the at least one set of feature matched distances and the determined one or more linear feature clusters, wherein a given linear feature group respectively comprises at least a first linear feature cluster associated with a first sub link and at least a second linear feature cluster associated with a second sub link; and generating the linear feature data, based on the determined plurality of linear feature groups.

In additional computer program product embodiments, for determining the plurality of linear feature groups, the operations further comprise grouping the first linear feature cluster and the second linear feature cluster into a linear feature group, when a difference between (i) the respective feature matched distance of the first linear feature cluster and (ii) the respective feature matched distance of the second linear feature cluster is less than a threshold difference value.

In additional computer program product embodiments, for determining the one or more linear feature clusters for a sub link of the plurality of sub links, the operations further comprise: identifying, from the detection data, a plurality of linear feature points associated with the sub link; determining, using the map data, a matched distance for each of the plurality of linear feature points associated with the sub link; and determining a linear feature cluster for the sub link based on a clustering criteria, wherein the clustering criteria comprises the determined matched distances, and wherein each linear feature cluster of the one or more linear feature clusters of the sub link comprises one or more linear feature points with identical matched distances.

In additional computer program product embodiments, the feature matched distance associated with the linear feature cluster of the one or more linear feature clusters is a weighted median of the corresponding matched distances associated with the linear feature cluster.

In additional computer program product embodiments, the operations further comprise removing diagonal detection data from the detection data, wherein the diagonal detection data includes at least two linear feature points, and wherein each of the at least two linear feature points is associated with a different linear feature cluster in the one or more linear feature clusters.

In additional computer program product embodiments, the operations further comprise updating the map data to include the generated linear feature data for the at least one link.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1 illustrates a block diagram showing a network environment of a system for generating linear feature data, in accordance with one or more example embodiments;

FIG. 2 illustrates a block diagram of the system for generating the linear feature data, in accordance with one or more example embodiments;

FIG. 3A illustrates a first working environment of the system for generating the linear feature data, in accordance with one or more example embodiments;

FIG. 3B illustrates a schematic diagram for determining, from sensor data, linear feature detection data associated with a link, in accordance with one or more example embodiments;

FIG. 3C illustrates a schematic diagram for determining one or more linear feature clusters for each of a plurality of sub links, in accordance with one or more example embodiments;

FIG. 3D illustrates a schematic diagram for determining a plurality of groups, based on the determined linear feature clusters, in accordance with one or more example embodiments;

FIG. 3E illustrates a flowchart for determining the plurality of linear feature groups, based on the determined linear feature clusters, a first set of feature matched distances and a second set of feature matched distances, in accordance with one or more example embodiments;

FIG. 4A illustrates a second working environment of the system for generating the linear feature data, in accordance with one or more example embodiments;

FIG. 4B illustrates a schematic diagram for determining, from sensor data, the linear feature detection data associated with at least one link, in accordance with one or more example embodiments;

FIG. 4C illustrates a schematic diagram for determining one or more linear feature clusters for each of a first link and a second link, in accordance with one or more example embodiments;

FIG. 4D illustrates a schematic diagram for determining a plurality of groups, based on the determined linear feature clusters, in accordance with one or more example embodiments;

FIG. 5 illustrates a flowchart depicting a method for generating the linear feature data, in accordance with one or more example embodiments;

FIG. 6A shows format of map data stored in a map database, in accordance with one or more example embodiments;

FIG. 6B shows another format of map data stored in the map database, in accordance with one or more example embodiments; and

FIG. 6C illustrates a block diagram of the map database, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for generating the linear feature data. Various embodiments are provided for determining, from sensor data, detection data associated with the at least one link. Hereinafter, ‘detection data’ and ‘linear feature detection data’ may be interchangeably used to mean the same. For instance, the liner feature detection data may include a plurality of linear feature points, where each linear feature point may indicate data (e.g., image data) of a linear feature. As used herein, the linear feature may correspond to a border of a link (and/or a border of a lane of the link), where the border may be represented by one or more of lane markings, guardrails, road curbs, road medians, road barriers, and the like. In some embodiments, the at least one link may include a plurality of sub links.

Various embodiments are provided for determining, using map data, one or more linear feature clusters for each of the plurality of sub links, based on the linear feature detection data. In some example embodiments, the one or more linear feature clusters may be determined based on a clustering criteria. In some embodiments, the one or more linear feature clusters may be associated with at least one set of feature matched distances, where the at least one set of feature matched distances includes a respective feature matched distance for each linear feature cluster.

Various embodiments are provided for determining a plurality of linear feature groups for the at least one link, based on the at least one set of feature matched distances and the determined one or more linear feature clusters, where a given linear feature group respectively includes at least a first linear feature cluster associated with a first sub link and at least a second linear feature cluster associated with a second sub link. The first sub link and the second sub link are adjacent to each other in the plurality of sub links. In some embodiments, the first linear feature cluster and the second linear feature cluster may be grouped if a difference between the respective feature matched distance of the first linear feature cluster and the respective feature matched distance of the second linear feature cluster is less than a threshold difference value.

Various embodiments are provided for generating the linear feature data, based on the determined plurality of linear feature groups. In various embodiments, the generated linear feature data may be used to update the map data and/or to provide one or more navigation functions. Some non-limiting examples of the navigation functions includes providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

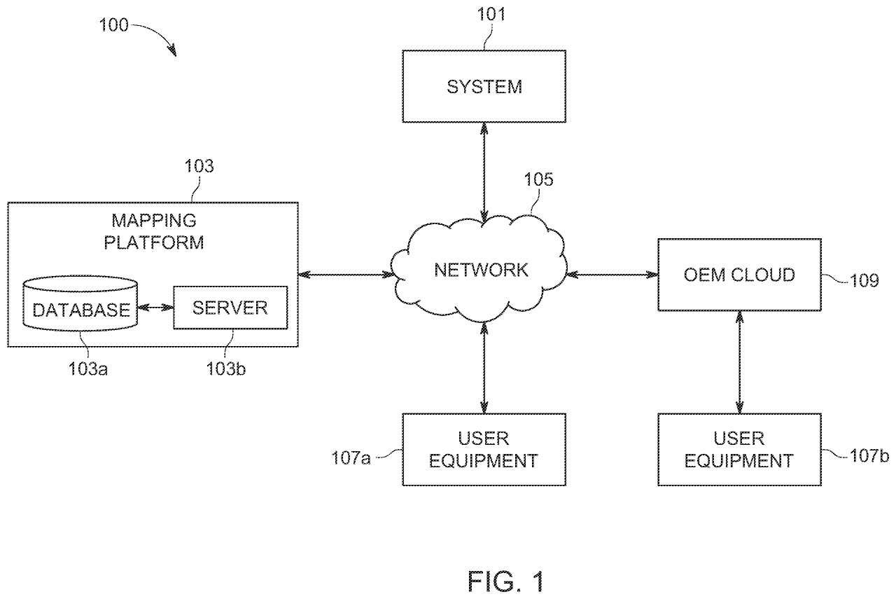

FIG. 1 illustrates a block diagram 100 showing a network environment of a system 101 for generating the linear feature data, in accordance with one or more example embodiments. The system 101 may be communicatively coupled, via a network 105, to one or more of a mapping platform 103, a user equipment 107a, and/or an OEM (Original Equipment Manufacturer) cloud 109. The OEM cloud 109 may be further connected to a user equipment 107b. The components described in the block diagram 100 may be further broken down into more than one component such as one or more sensors or application in user equipment and/or combined together in any suitable arrangement. Further, it is possible that one or more components may be rearranged, changed, added, and/or removed without deviating from the scope of the present disclosure.

In an example embodiment, the system 101 may be embodied in one or more of several ways as per the required implementation. For example, the system 101 may be embodied as a cloud-based service, a cloud-based application, a cloud-based platform, a remote server-based service, a remote server-based application, a remote server-based platform, or a virtual computing system. As such, the system 101 may be configured to operate inside the mapping platform 103 and/or inside at least one of the user equipment 107a and the user equipment 107b.

In some embodiments, the system 101 may be embodied within one or both of the user equipment 107a and the user equipment 107b, for example as a part of an in-vehicle navigation system, a navigation app in a mobile device and the like. In each of such embodiments, the system 101 may be communicatively coupled to the components shown in FIG. 1 to carry out the desired operations and wherever required modifications may be possible within the scope of the present disclosure. The system 101 may be implemented in a vehicle, where the vehicle may be an autonomous vehicle, a semi-autonomous vehicle, or a manually driven vehicle. In an embodiment, the system 101 may be deployed in a consumer vehicle to generate the linear feature data.

In some other embodiments, the system 101 may be a server 103b of the mapping platform 103 and therefore may be co-located with or within the mapping platform 103. In yet other embodiments, the system 101 may be implemented within an OEM (Original Equipment Manufacturer) cloud, such as the OEM cloud 109. The OEM cloud 109 may be configured to anonymize any data received from the system 101, such as the vehicle, before using the data for further processing, such as before sending the data to the mapping platform 103. In some embodiments, anonymization of data may be done by the mapping platform 103. Further, in yet other embodiments, the system 101 may be a standalone unit configured to generate the linear feature data for the autonomous vehicle. Additionally, the system 101 may be coupled with an external device such as the autonomous vehicle.

The mapping platform 103 may include a map database 103a (also referred to as geographic database 103a) for storing map data and a processing server 103b for carrying out the processing functions associated with the mapping platform 103. The map database 103a may store node data, road segment data or link data, point of interest (POI) data, road obstacles related data, traffic objects related data, posted signs related data, such as road sign data, or the like. The map database 103a may also include cartographic data and/or routing data. According to some example embodiments, the link data may be stored in link data records, where the link data may represent links or segments representing roads, streets, or paths, as may be used in calculating a route or recorded route information for determination of one or more personalized routes. The node data may be stored in node data records, where the node data may represent end points corresponding to the respective links or segments of the road segment data. One node represents a point at one end of the respective link and the other node represents a point at the other end of the respective link. The node at either end of a link corresponds to a location at which the road meets another road, e.g., an intersection, or where the road dead ends. An intersection may not necessarily be a place at which a turn from one road to another is permitted but represents a location at which one road and another road have the same latitude, longitude, and elevation. In some cases, a node may be located along a portion of a road between adjacent intersections, e.g., to indicate a change in road attributes, a railroad crossing, or for some other reason. (The terms “node” and “link” represent only one terminology for describing these physical geographic features and other terminology for these features is intended to be encompassed within the scope of these concepts.) The link data and the node data may represent a road network used by vehicles such as cars, trucks, buses, motorcycles, and/or other entities.

Additionally, the map database 103a may contain path segment and node data records, or other data that may represent pedestrian paths or areas in addition to or instead of the vehicle road record data, for example. The links/road segments and nodes may be associated with attributes, such as geographic coordinates and other navigation related attributes, as well as POIs, such as fueling stations, hotels, restaurants, museums, stadiums, offices, auto repair shops, buildings, stores, parks, etc. The navigation related attributes may include one or more of travel speed data (e.g. data indicative of a permitted speed of travel) on the road represented by the link data record, a travel direction data (e.g. data indicative of a permitted direction of travel) on the road represented by the link data record, the linear feature data on the road represented by the link data record, street address ranges of the road represented by the link data record, the name of the road represented by the link data record, and the like. As used herein, the ‘linear feature data’ may be data indicative of a linear feature along the road represented by the link data record. The linear feature may be at least one of lane markings, road curbs, guardrails, road medians, road barriers, and the like along the road. These various navigation related attributes associated with a link may be stored in a single data record or may be stored in more than one type of record.

Each link data record that represents other-than-straight link (for example, a curved link) may include shape location data. A shape location is a location along a link between its endpoints. For instance, to represent the shape of other-than-straight roads/links, a geographic database developer may select one or more shape locations along the link portion. The shape location data included in the link data record may indicate a position, (e.g., latitude, longitude, and optionally, altitude or elevation) of the selected shape point(s) along the represented link.

Additionally, the map database 103a may also include data about the POIs and their respective locations in the POI records. The map database 103a may further include data about places, such as cities, towns, or other communities, and other geographic features such as bodies of water, mountain ranges, etc. Such place or feature data may be part of the POI data or may be associated with POIs or POI data records (such as a data point used for displaying a city). In addition, the map database 103a may include event data (e.g., traffic incidents, construction activities, scheduled events, unscheduled events, etc.) associated with the POI data records or other records of the map database 103a.

The map database 103a may be maintained by a content provider e.g., a map developer. By way of example, the map developer may collect the map data to generate and enhance the map database 103a. There may be different ways used by the map developer to collect data. These ways may include obtaining data from other sources, such as municipalities or respective geographic authorities. In addition, the map developer may employ field personnel to travel by vehicle (also referred to as a dedicated vehicle) along roads throughout a geographic region to observe features and/or record information about them, for example. Also, remote sensing, such as aerial or satellite photography, may be used to collect the map data. In some example embodiments, the map data in the map database 103a may be stored as a digital map. The digital map may correspond to satellite raster imagery, bitmap imagery, or the like. The satellite raster imagery/bitmap imagery may include map features (such as link/road segments, nodes, and the like) and the navigation related attributes associated with the map features. In some embodiments, the map features may have a vector representation form. Additionally, the satellite raster imagery may include three-dimensional (3D) map data that corresponds to 3D map features, which are defined as vectors, voxels, or the like.

According to some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, the map data may be compiled (such as into a platform specification format (PSF format)) to organize and/or configure the data for performing navigation-related functions and/or services, such as route calculation, route guidance, map display, speed calculation, distance and travel time functions, navigation instruction generation and other functions, by a navigation device, such as by the user equipment 107a and/or 107b. The navigation-related functions may correspond to vehicle navigation, pedestrian navigation, navigation instruction suppression, navigation instruction generation based on user preference data or other types of navigation. The compilation to produce the end user databases may be performed by a party or entity separate from a map developer. For example, a customer of the map developer, such as a navigation device developer or other end user device developer, a navigation app service provider and the like may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment such as the user equipment 107a and/or the user equipment 107b to provide navigation and/or map-related functions. For example, the map database 103a may be used with the user equipment 107a and/or the user equipment 107b to provide an end user with navigation features. In such a case, the map database 103a may be downloaded or stored locally (cached) on the user equipment 107a and/or the user equipment 107b.

The processing server 103b may include processing means, and communication means. For example, the processing means may include one or more processors configured to process requests received from the user equipment 107a and/or the user equipment 107b. The processing means may fetch map data from the map database 103a and transmit the same to the user equipment 107b via the OEM cloud 109 in a format suitable for use by the one or both of the user equipment 107a and/or the user equipment 107b. In one or more example embodiments, the mapping platform 103 may periodically communicate with the user equipment 107a and/or the user equipment 107b via the processing server 103b to update a local cache of the map data stored on the user equipment 107a and/or the user equipment 107b. Accordingly, in some example embodiments, the map data may also be stored on the user equipment 107a and/or the user equipment 107b and may be updated based on periodic communication with the mapping platform 103 via the network 105.

The network 105 may be wired, wireless, or any combination of wired and wireless communication networks, such as cellular, Wi-Fi, internet, local area networks, or the like. In one embodiment, the network 105 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In some example embodiments, the user equipment 107a and the user equipment 107b may be any user accessible device such as a mobile phone, a smartphone, a portable computer, and the like that are portable in themselves or as a part of another portable/mobile object such as a vehicle. The user equipment 107a and 107b may include a processor, a memory, and a communication interface. The processor, the memory, and the communication interface may be communicatively coupled to each other. In some example embodiments, the user equipment 107a and 107b may be associated, coupled, or otherwise integrated with a vehicle, such as an advanced driver assistance system (ADAS), a personal navigation device (PND), a portable navigation device, an infotainment system and/or other device that may be configured to provide route guidance and navigation related functions to the user. In such example embodiments, the user equipment 107a and 107b may include processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 107a and 107b. For example, the user equipment 107a and 107b may be configured to execute and run mobile applications such as a messaging application, a browser application, a navigation application, and the like.

In one embodiment, at least one user equipment such as the user equipment 107a may be directly coupled to the system 101 via the network 105. For example, the user equipment 107a may be a dedicated vehicle (or a part thereof) for gathering data for development of the map data stored in the map database 103a. In another embodiment, at least one user equipment such as the user equipment 107b may be coupled to the system 101 via the OEM cloud 109 and the network 105. For example, the user equipment 107b may be a consumer vehicle or a probe vehicle (or a part thereof) and may be a beneficiary of the services provided by the system 101. In some example embodiments, one or more of the user equipment 107a and 107b may serve the dual purpose of a data gatherer and a beneficiary device. At least one of the user equipment 107a and 107b may be configured to capture sensor data associated with the link/road segment, while traversing along the link/road segment. For example, the sensor data may include image data of the linear feature along the link/road segment, among other things. The sensor data may be collected from one or more sensors in the user equipment 107a and/or user equipment 107b. As disclosed in conjunction with various embodiments disclosed herein, the system 101 may generate the linear feature data using the sensor data and the map database 103a data.

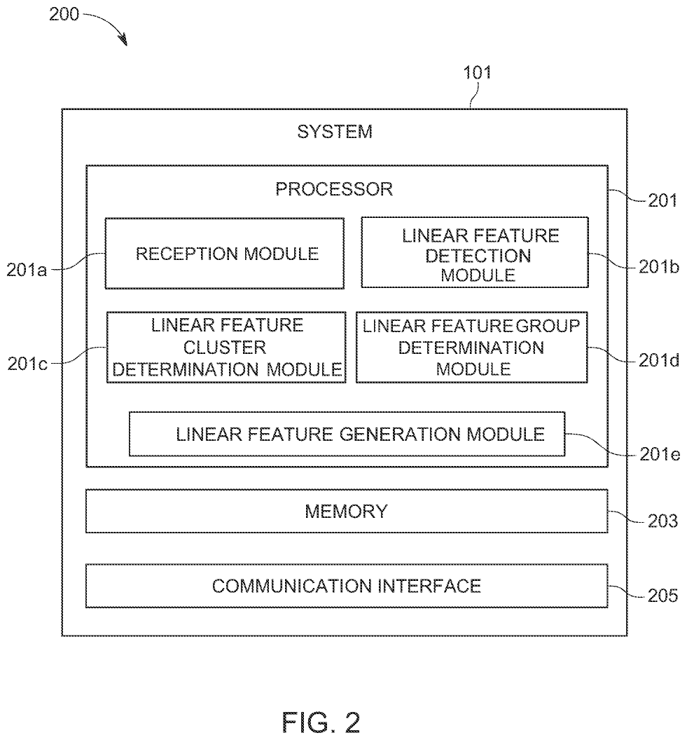

FIG. 2 illustrates a block diagram 200 of the system 101 for generating the linear feature data, in accordance with one or more example embodiment. The system 101 may include at least one processor 201, a memory 203, and a communication interface 205. Further, the system 101 may include a reception module 201a, a linear feature detection module 201b, a linear feature cluster determination module 201b, a linear feature group determination module 201d, and a linear feature generation module 201e. In an embodiment, the reception module 201a may be configured to obtain the sensor data. In an embodiment, the linear feature detection module 201b may be configured to determine, from the sensor data, linear feature data associated with at least one link. In an embodiment, the at least one link may include a plurality of sub links. In an embodiment, the linear feature cluster determination module 201c may be configured to determine, using map data, one or more linear feature clusters respectively for each of the plurality of sub links, based on the linear feature detection data. In an example embodiment, the one or more linear feature clusters may be associated with at least one set of feature matched distances, where the at least one set of feature matched distances include a feature matched distance for each linear feature cluster. In an embodiment, the linear feature group determination module 201d may be configured to generate a plurality of linear feature groups for the at least one link, based on the at least one set of feature matched distances, and the determined one or more linear feature clusters. For instance, a given linear feature group respectively includes at least a first linear feature cluster associated with the first sub link and at least a second linear feature cluster associated with a second link, where the first sub link and the second sub link are adjacent to each other within the plurality of sub links. In an embodiment, the linear feature generation module 201e may be configured to generate the linear feature data, based on the determined plurality of linear feature groups.

According to an embodiment, each of the modules 201a-201e may be embodied in the processor 201. The processor 201 may retrieve computer-executable instructions that may be stored in the memory 203 for execution of the computer-executable instructions, which when executed configures the processor 201 for generating the linear feature data.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

Additionally, or alternatively, the processor 201 may include one or more processors capable of processing large volumes of workloads and operations to provide support for big data analysis. In an example embodiment, the processor 201 may be in communication with the memory 203 via a bus for passing information to mapping platform 103. The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the system 101 to carry out various functions in accordance with an example embodiment of the present disclosure. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present disclosure while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

In some embodiments, the processor 201 may be configured to provide Internet-of-Things (IoT) related capabilities to a user of the system 101, where the user may be a traveler, a driver of the vehicle and the like. In some embodiments, the user may be or correspond to an autonomous or semi-autonomous vehicle. The IoT related capabilities may in turn be used to provide smart navigation solutions by providing real time updates to the user to take pro-active decision on lane maintenance, speed determination, lane-level speed determination, turn-maneuvers, lane changes, overtaking, merging and the like. The system 101 may be accessed using the communication interface 205. The communication interface 205 may provide an interface for accessing various features and data stored in the system 101. For example, the communication interface 205 may include I/O interface which may be in the form of a GUI, a touch interface, a voice enabled interface, a keypad, and the like. For example, the communication interface 205 may be a touch enabled interface of a navigation device installed in a vehicle, which may also display various navigation related data to the user of the vehicle. Such navigation related data may include information about upcoming conditions on a route, route display and alerts about lane maintenance, turn-maneuvers, vehicle speed, and the like.

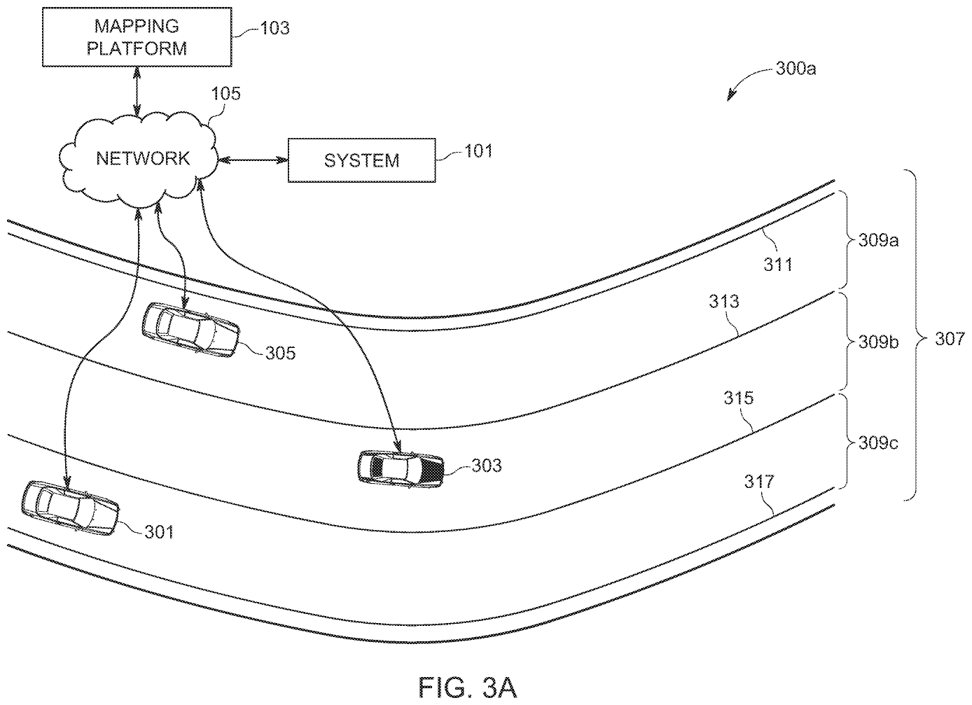

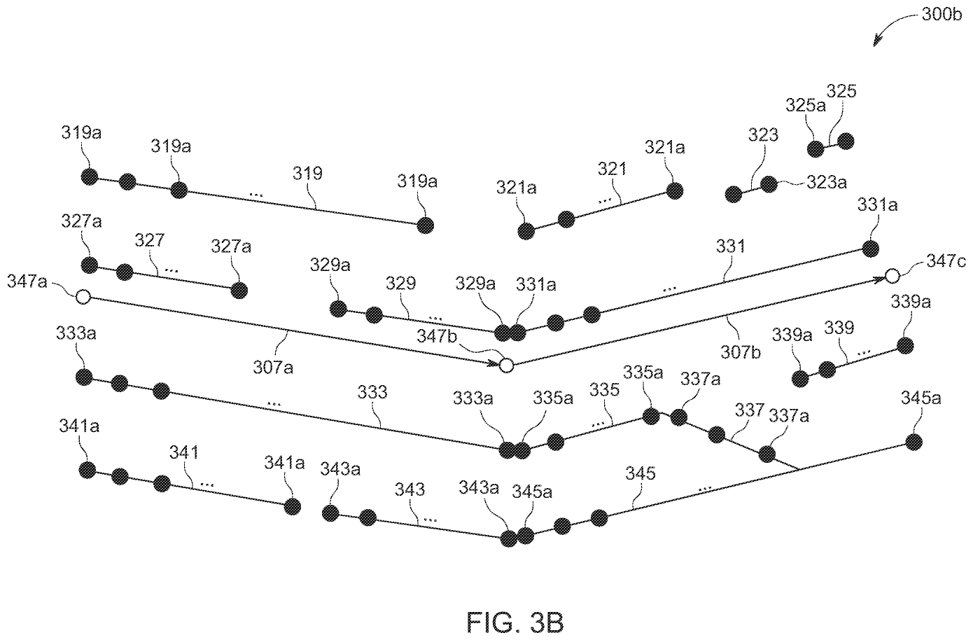

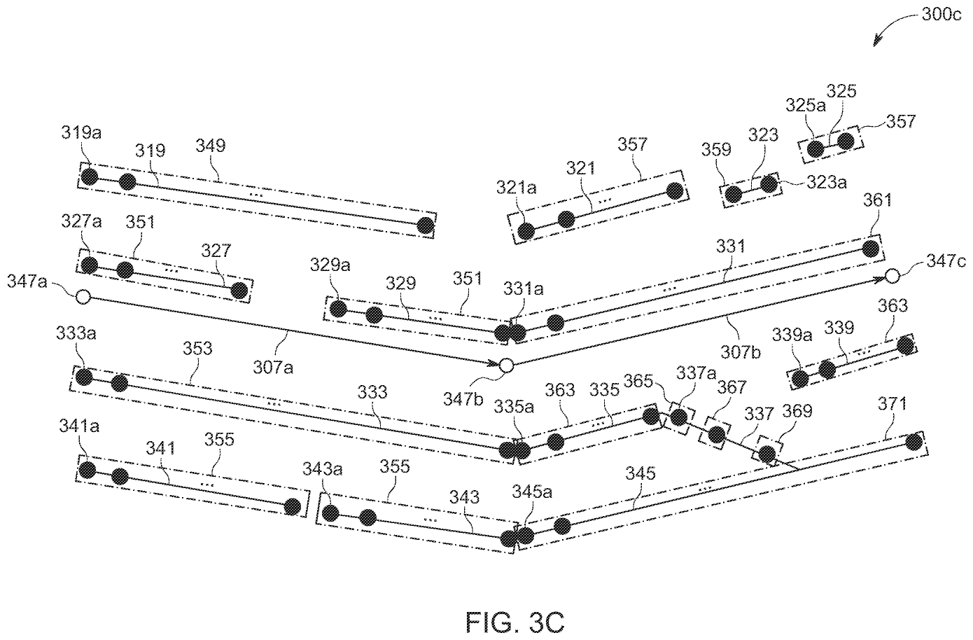

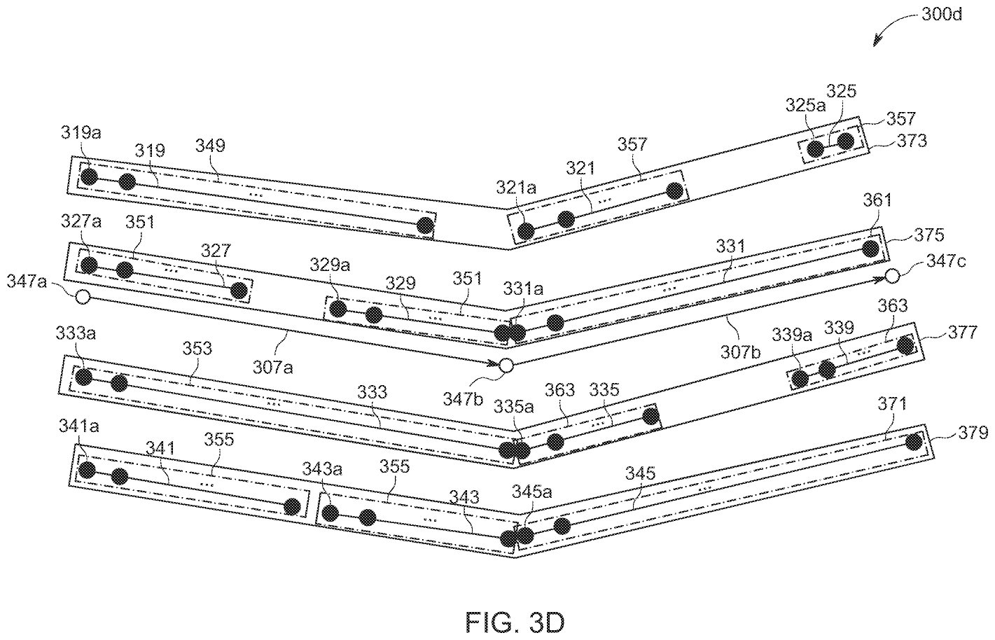

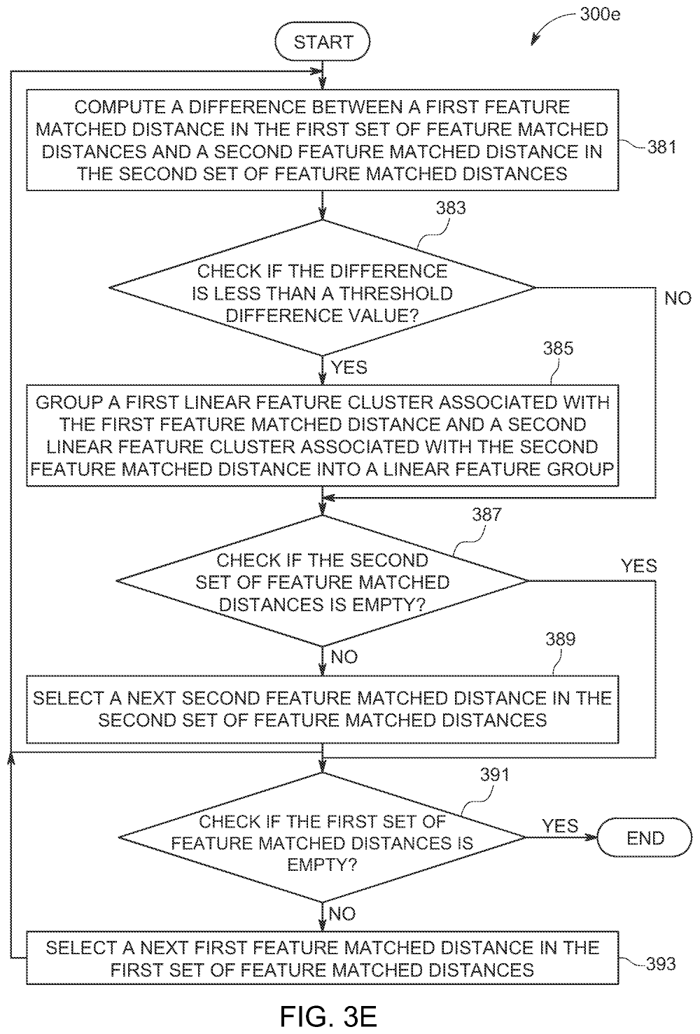

FIG. 3A illustrates a first working environment 300a of the system 101 for generating the linear feature data, in accordance with one or more example embodiments. As illustrated in FIG. 3A, the first working environment 300a includes the system 101, the mapping platform 103, the network 105, a plurality of vehicles 301, 303, and 305, a link 307, linear features 311, 313, 315 and 317 associated with the link 307. Each of the plurality of vehicles 301, 303, and 305 may correspond to any one of: an autonomous vehicle, a semi-autonomous vehicle, or a manual vehicle. As used herein, the autonomous vehicle may be a vehicle that is capable of sensing its environment and operating without human involvement. For instance, the autonomous vehicle may be a self-driving car and the like. As used herein, the ‘vehicle’ may include a motor vehicle, a non-motor vehicle, an automobile, a car, a scooter, a truck, a van, a bus, a motorcycle, a bicycle, a Segway, and/or the like.

As used herein, the ‘link’ (e.g., the link 307) may be a road segment between two nodes. The link 307 may be a freeway, an expressway, a highway, or the like. The link 307 may include three lanes 309a, 309b, and 309c, as illustrated in FIG. 3A. For purpose of explanation, the link 307 comprising three lanes 309a, 309b, and 309c is considered, however the link 307 may include any finite number of lanes without deviating from the scope of the present disclosure.

Each of the lanes 309a, 309b, and 309c may be identified (or defined) by at least two linear features. As used herein, the ‘linear feature’ may be a border (or a boundary) of one particular lane of a link (e.g., the link 307), a border (or a boundary) of the link, and/or a shared border (or a shared boundary) between two lanes of the links. For instance, the lane 309a may be identified by the linear features 311 and 313. Similarly, the lane 309b may be identified by the linear features 313 and 315 and the lane 309c may be identified by the linear features 315 and 317. For instance, the linear features 311 and 317 may the borders of the link 307. For instance, the linear feature 313 may be the shared boarder between the lanes 309a and 309b. Similarly, the linear feature 315 may be the shared boarder between the lanes 309b and 309c. The linear features 311, 313, 315, and 317 may include, but are not limited to, at least one of the lane markings, the guardrails, the road curbs, the road medians, and/or the road barriers.

Some embodiments are based on the recognition that the linear features 311, 313, 315, and 317 may be used in vehicle navigation for assisting the vehicles 301, 303, and/or 305. For instance, the linear features 311, 313, 315, and 317 may be used in lane maintenance application. To this end, in some embodiments, the vehicles 301, 303, and/or 305 may be equipped with various sensors to capture the linear features 311, 313, 315, and 317. For instance, the sensors may include a radar system, a LiDAR system, a global positioning sensor for gathering location data (e.g., GPS), image sensors, temporal information sensors, orientation sensors augmented with height sensors, tilt sensors, and the like. In some example embodiments, the sensors may collect the linear features 311, 313, 315, and 317 as linear feature points, leading to linear feature detection data. In these embodiments, sensor data obtained from the sensors include the linear feature detection data, among other things. For instance, each linear feature point in the linear feature detection data may represent image data corresponding to at least one of the linear features 309, 311, 313, and 315.

However, in most of cases, the sensors may fail to continuously capture the linear features 311, 313, 315, and 317, leading to discontinuities in the linear feature detection data. For instance, the sensors may fail to continuously capture the linear features 311, 313, 315, and 317, due to occlusions (caused by interference of other vehicles), noise in the sensors, or other defects in the sensors. In other words, the discontinuities in the linear feature detection data may occur when the sensors fail to completely capture the linear features 311, 313, 315, and 317. As a result, a gap may be formed between any two consecutive linear feature points in the linear feature detection data. As used herein, the gap between any two consecutive linear feature points may be indicative of a distance of discontinuity. Hereinafter, the ‘discontinuities in the linear feature detection data’ and ‘discontinuous detection data’ may be interchangeably used to mean the same. In some instances, the gap between two consecutive linear feature points may be huge. For instance, the gap may be greater than a threshold distance of discontinuity. In these cases, the gap should not be complemented (filled) using a heading-and-distance-bound algorithm. According to the heading-and-distance-bound algorithm, the gap between two consecutive linear feature points may be complemented, if a heading difference of the two consecutive linear feature points is within a threshold heading value and the distance between the two consecutive linear feature points is less than the threshold distance of discontinuity.

Further, the linear feature data extracted from the sensor data may include lateral position error data, when (i) the vehicle(s) is not propagating within the lanes and/or (ii) there are defects in the sensor. Furthermore, the linear feature data extracted from the sensor data may include diagonal detection data when the vehicle(s) is propagating from one lane to another lane.

Thereby, the linear feature detection data extracted from the sensor data may not be accurate to provide the vehicle navigation. Furthermore, if this inaccurate linear feature detection data is used in the vehicle navigation, a vehicle may end-up with unwanted conditions such as entering a wrong lane, road accidents, traffic congestions, vehicle efficiency reduction, environmental pollutions, and the like. To this end, when the linear feature detection data is inaccurate, the system 101 is provided for generating the linear feature data from the in accurate linear feature detection data such that the unwanted conditions are avoided. Further, to generate the linear feature data, the system 101 may be configured as explained in the detailed description of FIG. 3B-FIG. 3E.

FIG. 3B illustrates a schematic diagram 300b for determining, from the sensor data, the linear feature detection data associated with the link 307, in accordance with one or more example embodiments. FIG. 3B is explained in conjunction with FIG. 3A. As illustrated in FIG. 3B, the schematic diagram 300b may include linear feature detection data 319, 321, 323, 325, 327, 329, 331, 333, 335, 337, 339, 341, 343, and 345, a plurality of sub links 307a and 307b, and a plurality of nodes 347a, 347b, and 347c. In an embodiment, the system 101 may be configured to obtain, from the sensors, the sensor data. For instance, the reception module 201a may obtain the sensor data from the sensors. In an embodiment, the sensor data may include the linear feature detection data 319, 321, 323, 325, 327, 329, 331, 333, 335, 337, 339, 341, 343, and 345. For instance, the linear feature detection data 319, 321, 323, 325, 327, 329, 331, 333, 335, 337, 339, 341, 343, and 345 may be obtained from a plurality of vehicles (e.g., the vehicles 301, 303, and 305). The linear feature detection data 319, 321, 323, and 325 may correspond to the linear feature 311 of the link 307. The linear feature detection data 327, 329, and 331 may correspond to the linear feature 313 of the link 307. The linear feature detection data 333, 335, 337, and 339 may correspond to the linear feature 315 of the link 307. The linear feature detection data 341, 343, and 345 may correspond to the linear feature 317 of the link 307. In an embodiment, each of the linear feature detection data 319, 321, 323, 325, 327, 329, 331, 333, 335, 337, 339, 341, 343, and 345 may include a plurality of linear feature points. For instance, the linear feature detection data 319 may include a plurality of linear feature points 319a, where each linear feature point 319a may be data (e.g., image data) associated with the corresponding linear feature, such as the linear feature 311 corresponding to the linear feature detection data 319. Similarly, the linear feature detection data 321 may include a plurality of linear feature points 321a, the linear feature detection data 323 may include a plurality of linear feature points 323a, the linear feature detection data 325 may include a plurality of linear feature points 325a, the linear feature detection data 327 may include a plurality of linear feature points 327a, the linear feature detection data 329 may include a plurality of linear feature points 329a, the linear feature detection data 331 may include a plurality of linear feature points 331a, the linear feature detection data 333 may include a plurality of linear feature points 333a, the linear feature detection data 335 may include a plurality of linear feature points 335a, the linear feature detection data 337 may include a plurality of linear feature points 337a, the linear feature detection data 339 may include a plurality of linear feature points 339a, the linear feature detection data 341 may include a plurality of linear feature points 341a, the linear feature detection data 343 may include a plurality of linear feature points 343a, and the linear feature detection data 345 may include a plurality of linear feature points 345a.

In an example embodiment, the sensor data may further include time stamp data, vehicle location data, and lateral position data along with the linear feature detection data 319, 321, 323, 325, 327, 329, 331, 333, 335, 337, 339, 341, 343, and 345. The time stamp data may include a time stamp for each linear feature point of the linear feature detection data 319, 321, 323, 325, 327, 329, 331, 333, 335, 337, 339, 341, 343, and 345. As used herein, the time stamp may indicate a time instance at which a particular linear feature point was recorded by the sensors. The vehicle location data may include a vehicle location for each linear feature point of the linear feature detection data 319, 321, 323, 325, 327, 329, 331, 333, 335, 337, 339, 341, 343, and 345. As used herein, the vehicle location may indicate a location of a vehicle at where a particular linear feature point was recorded by the sensors.

The lateral position data may include a lateral position distance for each linear feature point of the linear feature detection data 319, 321, 323, 325, 327, 329, 331, 333, 335, 337, 339, 341, 343, and 345. As used herein, the lateral position distance may be a distance from the vehicle to a particular linear feature point recorded by the sensors. In some embodiments, the lateral position distance may be associated with a sign (e.g., a positive sign or a negative sign). For instance, the lateral position distance with the positive sign may indicate that the particular linear feature point is located on right side with respect to the vehicle in a direction of travel of the vehicle. Conversely, the lateral position distance with the negative sign may indicate that the particular linear feature point is located on left side with respect to the vehicle in a direction of travel of the vehicle.

For example, once the system 101 receives the sensor data (e.g., the linear feature points 319a, the time stamp data associated with the linear feature points 319a, the vehicle location data associated with the linear feature points 319a, and the lateral position data associated with the linear feature points 319a), the system 101 may be configured to identify, using the map data stored in the map database 103a, the link 307 based on the sensor data. For instance, the system 101 (e.g., linear feature detection module 201b) may map-match the sensor data (specifically, the vehicle location data) with the map data to identify the link 307. In various embodiments, the link 307 may be identified as at least one vector line. In some example embodiments, when the link 307 corresponds to the other-than-straight road segment (e.g., a curved link), the system 101 may be configured to identify, using the map data, the plurality of nodes 347a, 347b, and 347c associated with the link 307. For instance, the node 347a may be a start node of the link 307, the node 307c may be an end node of the link 307, and the node 307b may be a shape location between the nodes 307a and 307c. For example, the node 307b may be used to represent the curvature nature of the link 307. In other words, the node 307b may divide the link 307 (represented by the vector line) into at least two sub links 307a and 307b. Accordingly, when the link 307 corresponds to the other-than-straight road segment, the system 101 may be configured to identify at least two sub links 307a and 307b that represent the link 307, based on the plurality of nodes 347a, 347b, and 347c. For instance, the sub link 307a (also referred to as a first sub link 307a) and the sub link 307b (also referred to as a second sub link 307b) may be identified as the vector lines as illustrated in the FIG. 3B. For purpose of explanation, the link 307 comprising two sub links 307a and 307b is considered. However, the link 307 may include any finite number of sub links without deviating from the scope of the present disclosure.

Once the link 307 (or the plurality of sub links 307a and 307b) are identified, the system 101 may be configured to determine, from the sensor data, the linear feature detection data 319 associated with the link 307 by arranging the plurality of linear feature points 319a with respect to the link 307 (or the plurality of sub links 307a and 307b), based on the vehicle location data associated with the linear feature points 319a, the time stamp data associated with the linear feature points 319a, the lateral position data associated with the linear feature points 319a, or a combination thereof. For instance, the linear feature detection module 201b may be configured to determine, from the sensor data, the linear feature detection data 319 associated with the link 307.

Similarly, the system 101 may determine, from the sensor data, the linear feature detection data 321, 323, 325, 327, 329, 331, 333, 335, 337, 339, 341, 343, and 345 associated with the link 307. Once the linear feature detection data 319, 321, 323, 325, 327, 329, 331, 333, 335, 337, 339, 341, 343, and 345 associated with the link 307 are determined, the system 101 may be further configured to determine a status of the linear feature detection data 319, 321, 323, 325, 327, 329, 331, 333, 335, 337, 339, 341, 343, and 345 associated with the link 307. For instance, the linear feature detection module 201b may be configured to determine the status of the linear feature detection data 319, 321, 323, 325, 327, 329, 331, 333, 335, 337, 339, 341, 343, and 345. In an embodiment, the system 101 may determine the status of the linear feature detection data 319, 321, 323, 325, 327, 329, 331, 333, 335, 337, 339, 341, 343, and 345 as at least one of the discontinuous detection data or continuous detection data. For instance, the system 101 may determine the status as the discontinuous detection data, if a distance between any two consecutive linear feature points of the linear feature detection data 319, 321, 323, 325, 327, 329, 331, 333, 335, 337, 339, 341, 343, and 345 is greater than a threshold distance. In other words, the system 101 may determine the status as the discontinuous detection data, if a distance between any two consecutive linear feature detection data of the linear feature detection data 319, 321, 323, 325, 327, 329, 331, 333, 335, 337, 339, 341, 343, and 345 is greater than a threshold distance. For instance, the system 101 may determine the status as the discontinuous detection data, if a distance between the linear feature detection data 319 (or the linear feature point 319a) and the linear feature detection data 321 (or the linear feature point 321a) is greater than the threshold distance.

Alternatively, the system 101 may determine the status as the continuous detection data, if distances between all consecutive linear feature detection data of the linear feature detection data 319, 321, 323, 325, 327, 329, 331, 333, 335, 337, 339, 341, 343, and 345 are less than the threshold distance. For instance, if the status is determined as the continuous detection data, the system 101 may use the linear feature detection data 319, 321, 323, 325, 327, 329, 331, 333, 335, 337, 339, 341, 343, and 345 as the linear feature data to aid a vehicle in vehicle navigation. Alternatively, in response to determining the status as the discontinuous detection data, the system 101 may be configured to determine, using the map data, one or more linear feature clusters respectively for each of the sub links 307a and 307b (or the link 307), based on the linear feature detection data 319, 321, 323, 325, 327, 329, 331, 333, 335, 337, 339, 341, 343, and 345. For instance, the system 101 may determine the one or more linear feature clusters for each of the sub links 307a and 307b as explained in the detailed description of FIG. 3C.

FIG. 3C illustrates a schematic diagram 300c for determining the one or more linear feature clusters for each of the sub links 307a and 307b, in accordance with one or more example embodiments. FIG. 3C is explained in conjunction with FIG. 3B. As illustrated in FIG. 3C, the schematic diagram 300c may include the linear feature detection data 319, 321, 323, 325, 327, 329, 331, 333, 335, 337, 339, 341, 343, and 345, the plurality of sub links 307a and 307b, the plurality of nodes 347a, 347b, and 347c, one or more linear feature clusters 349, 351, 353, and 355 associated with the sub link 307a, and one or more linear feature clusters 357, 359, 361, 363, 365, 367, 369, and 371 associated with the sub link 307b. According to an embodiment, the system 101 may be configured to determine, based on the map data and the linear feature detection data 319, 321, 323, 325, 327, 329, 331, 333, 335, 337, 339, 341, 343, and 345, the one or more linear feature clusters 349, 351, 353, and 355 for the sub link 307a and the one or more linear feature clusters 357, 359, 361, 363, 365, 367, 369, and 371 for the sub link 307b. For instance, the linear feature cluster determination module 201c may be configured to determine, based on the map data and the linear feature detection data 319, 321, 323, 325, 327, 329, 331, 333, 335, 337, 339, 341, 343, and 345, the one or more linear feature clusters 349, 351, 353, and 355 for the sub link 307a and the one or more linear feature clusters 357, 359, 361, 363, 365, 367, 369, and 371 for the sub link 307b.

In an example embodiment, to determine the one or more linear feature clusters 349, 351, 353, and 355 for the sub link 307a, the system 101 may be configured to identify, from the linear feature detection data 319, 321, 323, 325, 327, 329, 331, 333, 335, 337, 339, 341, 343, and 345, linear feature detection data associated with the sub link 307a. For instance, the linear feature detection data 319, 327, 329, 333, 341, and 343 may be identified as the linear feature detection data associated with the sub link 307a.

Once the linear feature detection data 319, 327, 329, 333, 341, and 343 (or the plurality of linear feature points 319a, 327a, 329a, 333a, 341a, and 343a) associated with the sub link 307a are identified, the system 101 may be configured to determine, using the map data, a matched distance for each linear feature point of each of the linear feature detection data 319, 327, 329, 333, 341, and 343. As used herein, the matched distance may be a distance between a sub link (e.g., the sub link 307a) and a particular linear feature point. Accordingly, in an example embodiment, the system 101 may determine the matched distance between the sub link 307a and each linear feature point of each of the linear feature detection data 319, 327, 329, 333, 341, and 343. In other words, the system 101 may determine the matched distances between the sub link 307a and the plurality of linear feature points 319a, the matched distances between the sub link 307a and the plurality of linear feature points 327a, the matched distances between the sub link 307a and the plurality of linear feature points 329a, the matched distances between the sub link 307a and the plurality of linear feature points 333a, the matched distances between the sub link 307a and the plurality of linear feature points 341a, and the matched distances between the sub link 307a and the plurality of linear feature points 343a.

Once the matched distance for each linear feature point of each of the linear feature detection data 319, 327, 329, 333, 341, and 343 is determined, the system 101 may be configured to determine the linear feature cluster 349, based on a clustering criteria. According to the clustering criteria, the system 101 may determine one linear feature cluster by clustering one or more linear feature points of the plurality of linear feature points 319a, 327a, 329a, 333a, 341a, and 343a into one linear feature cluster, if the matched distance associated with each of the one or more linear feature points is identical (or similar). So accordingly, for example, the system 101 may cluster the plurality of linear feature points 319a into the linear feature cluster 349, if the matched distances associated with each of the plurality of linear feature points 319a is identical. For example, the system 101 may cluster the plurality of linear feature points 327a and the plurality of linear feature points 329a into the linear feature cluster 351, if the matched distances associated with each of the plurality of linear feature points 327a and 329a are identical. Similarly, the system 101 may cluster the plurality of linear feature points 333a into the linear feature cluster 353; and the plurality of linear feature points 341a and 343a into the linear feature 355. To this end, the system 101 may determine the one or more linear feature clusters 349, 351, 353, and 355 associated with the sub link 307a, where each linear feature cluster may include one or more linear feature points of the plurality of linear feature points 319a, 327a, 329a, 333a, 341a, and 343a such that the matched distance associated with each of the one or more linear feature points is identical. The one or more linear feature clusters 349, 351, 353, and 355 associated with the sub link 307a (the first sub link 307a) may be referred to as one or more first linear feature clusters 349, 351, 353, and 355.

Once the one or more linear feature clusters 349, 351, 353, and 355 are determined for the sub link 307a, the system 101 may be configured to identify the sub link 307b that is adjacent (or connected) to the sub link 307a. For instance, the system 101 may identify, in the direction of travel defined by the sub link 307a, the sub link 307b is adjacent to the sub link 307a.

Further, the system 101 may be configured to identify, from the linear feature detection data 319, 321, 323, 325, 327, 329, 331, 333, 335, 337, 339, 341, 343, and 345, linear feature detection data associated with the sub link 307b. For instance, the linear feature detection data 321, 323, 325, 331, 335, 337, 339, and 345 may be identified as the linear feature detection data associated with the sub link 307b. Once the linear feature detection data 321, 323, 325, 331, 335, 337, 339, and 345 (or the plurality of linear feature points 321a, 323a, 325a, 331a, 335a, 337a, 339a, and 345a) associated with the sub link 307b are identified, the system 101 may be configured to determine, using the map data, the matched distance for each linear feature point of each of the linear feature detection data 321, 323, 325, 331, 335, 337, 339, and 345. In an example embodiment, the system 101 may determine the matched distance between the sub link 307b and each linear feature point of each of the linear feature detection data 321, 323, 325, 331, 335, 337, 339, and 345.

Once the matched distance for each linear feature point of each of the linear feature detection data 321, 323, 325, 331, 335, 337, 339, and 345 is determined, the system 101 may be configured to cluster, based on the clustering criteria, the linear feature detection data 321, 323, 325, 331, 335, 337, 339, and 345 associated with the sub link 307b into the one or more linear feature clusters 357, 359, 361, 363, 365, 367, 369, and 371. For example, the system 101 may cluster the plurality of linear feature points 321a and the plurality of linear feature points 325a into the linear feature cluster 357, if the matched distance associated with each of the plurality of linear feature points 321a and the matched distance associated with each of the plurality of linear feature points 325a are identical. Similarly, the system 101 may cluster the plurality of linear feature points 331a into the linear feature cluster 361; the plurality of linear feature points 335a and the plurality of linear feature points 339a into the linear feature cluster 363; and the plurality of linear feature points 345a into the linear feature cluster 371. Specifically, the matched distance associated each linear feature point 337a of the linear feature detection data 337 may be continuously varying, so accordingly, the system 101 may cluster each linear feature point 337a into a separate cluster. For example, the system 101 may generate three linear feature clusters 365, 367, and 369 for the three linear feature points 337a, since the matched distance associated with each linear feature point 337a of the linear feature detection data 337 is different (or continuously varying). To this end, the system 101 may determine the one or more linear feature clusters 357, 359, 361, 363, 365, 367, 369, and 371. The one or more linear feature clusters 357, 359, 361, 363, 365, 367, 369, and 371 associated with the sub link 307b (the second sub link 307b) may also referred to as one or more second linear feature clusters 357, 359, 361, 363, 365, 367, 369, and 371.

In this way, the system 101 may be configured to determine the one or more linear feature clusters 349, 351, 353, and 355 for the sub link 307a and the one or more linear feature clusters 357, 359, 361, 363, 365, 367, 369, and 371 for the sub link 307b. Once the linear feature clusters 349, 351, 353, 355, 357, 359, 361, 363, 365, 367, 369, and 371 are determined, the system 101 may be configured to determine a plurality of linear feature groups for the link 307, based on the determined linear feature clusters 349, 351, 353, 355, 357, 359, 361, 363, 365, 367, 369, and 371.

Some embodiments are based on the recognition that the linear feature detection data (or the linear feature points) reported by the vehicle(s) (e.g., the vehicles 301, 305, and 307) may be inaccurate, if the vehicle(s) is traversing from one to another lane. Hereinafter, ‘the linear feature detection data reported by the vehicle(s) while the vehicle(s) is traversing from one lane to another lane’ and ‘diagonal detection data’ may be interchangeably used to mean the same.

To this end, in some example embodiments, the system 101 may be further configured to remove from the linear feature detection data 319, 321, 323, 325, 327, 329, 331, 333, 335, 337, 339, 341, 343, and 345, the diagonal detection data, before generating the plurality of linear feature groups. In an example embodiment, the system 101 may remove linear feature detection data as the diagonal detection data, if the linear feature detection data includes at least two linear feature points such that each of the at least two linear feature points is associated with a different linear feature cluster in the determined linear feature clusters. For example, the system 101 may remove the linear feature detection data 337 as the diagonal detection data, because the linear feature detection data 337 includes the different linear feature points 337a associated with different linear feature clusters: the linear feature cluster 365, the linear feature cluster 367, and the linear feature cluster 369.

In an alternate embodiment, the system 101 may remove, from the linear feature detection data 319, 321, 323, 325, 327, 329, 331, 333, 335, 337, 339, 341, 343, and 345, the diagonal detection data (e.g. the linear feature detection data 337), by comparing the linear feature detection data 319, 321, 323, 325, 327, 329, 331, 333, 335, 337, 339, 341, 343, and 345 with a pre-stored image (e.g. a satellite image) representing the linear features 311, 313, 315, and 317 of the link 307.

Some embodiments are based on the recognition that the linear feature detection data 319, 321, 323, 325, 327, 329, 331, 333, 335, 337, 339, 341, 343, and 345 may also include lateral position error data, due to defects in the sensors, noise in the sensors, or the like. To this end, in some example embodiments, the system 101 may be configured to remove from the linear feature detection data 319, 321, 323, 325, 327, 329, 331, 333, 335, 337, 339, 341, 343, and 345, the lateral position error data. As used herein, the lateral position error data may be linear feature detection data that do not accurately represent the linear feature (e.g., at least one of the linear features 311, 313, 315, and 317). For instance, the lateral position error data may be linear feature detection data that include at least one feature point such that the matched distance associated with the at least one linear feature point is not similar to an actual matched distance from the link 307 to a linear feature point representing the linear feature. In an example embodiment, the system 101 may remove from the linear feature detection data 319, 321, 323, 325, 327, 329, 331, 333, 335, 337, 339, 341, 343, and 345, the lateral position error data, by comparing the linear feature detection data 319, 321, 323, 325, 327, 329, 331, 333, 335, 337, 339, 341, 343, and 345 with the pre-stored image. For example, the system 101 may remove the linear feature detection data 323 as the lateral position error data, by comparing the linear feature detection data 319, 321, 323, 325, 327, 329, 331, 333, 335, 337, 339, 341, 343, and 345 with the pre-stored image.

In some example embodiments, after removing the linear feature detection data 337 and/or the linear feature detection data 323 from the linear feature detection data 319, 321, 323, 325, 327, 329, 331, 333, 335, 337, 339, 341, 343, and 345, the system 101 may be configured to determine the plurality of linear feature groups, based on the determined linear feature clusters 349, 351, 353, 355, 357, 361, 363, and 371. For instance, the system 101 may determine the plurality of linear feature groups, based on the determined linear feature clusters 349, 351, 353, 355, 357, 361, 363, and 371 as explained in the detailed description of FIG. 3D.

FIG. 3D illustrates a schematic diagram 300d for determining the plurality of linear feature groups, based on the determined linear feature clusters 349, 351, 353, 355, 357, 361, 363, and 371, in accordance with one or more example embodiments. FIG. 3D is explained in conjunction with FIG. 3C. As illustrated in the FIG. 3D, the schematic diagram 300d may include the linear feature detection data 319, 321, 325, 327, 329, 331, 333, 335, 339, 341, 343, and 345, the plurality of sub links 307a and 307b, the plurality of nodes 347a, 347b, and 347c, the linear feature clusters 349, 351, 353, 355, 357, 361, 363, and 371, a plurality of linear feature groups 373, 375, 377, and 379. According to an embodiment, the system 101 may be configured to determine the plurality of linear feature groups 373, 375, 377, and 379 for the link 307, based on the determined linear feature clusters 349, 351, 353, 355, 357, 361, 363, and 371. For instance, the linear feature group determination module 201d may be configured to determine the plurality of linear feature groups 373, 375, 377, and 379 for the link 307, based on the determined linear feature clusters 349, 351, 353, 355, 357, 361, 363, and 371.

In an example embodiment, to determine the plurality of linear feature groups 373, 375, 377, and 379, the system 101 may be configured to determine at least one set of matched distance for the link 307, based on the determined linear feature clusters 349, 351, 353, 355, 357, 361, 363, and 371. For instance, the system 101 may determine a set of feature matched distances for each of the plurality of sub links 307a and 307b, based on the determined linear feature clusters 349, 351, 353, 355, 357, 361, 363, and 371. For instance, the system 101 may determine a first set of feature matched distances for the sub link 307a (the first sub link 307a) and a second set of feature matched distances for the sub link 307b (the second sub link 307b). The first set of feature matched distances may be associated with the one or more first linear feature clusters 349, 351, 353, and 355. The second set of feature matched distances may be associated with the one or more second linear feature clusters 357, 361, 363, and 371.

In an example embodiment, to determine the first set of feature matched distances, the system 101 may be configured to compute a respective feature matched distance for each of the one or more linear feature clusters 349, 351, 353, and 355 associated with the sub link 307a. For example, to compute the feature matched distance for the linear feature cluster 349, the system 101 may be configured to compute a weighted median of the matched distances associated with the plurality of linear feature points 319a. Accordingly, the feature matched distance associated the linear feature cluster 349 may be the weighted median of the matched distances associated with the plurality of linear feature points 319a of the linear feature cluster 349. In an example embodiment, to compute the weighted median of the matched distances associated with the plurality of linear feature points 319a, the system 101 may be configured to assign a weight for each matched distance associated with each of the plurality of linear feature points 319a, based on a length of the linear feature cluster 349 and/or the time stamp associated with each of the plurality of linear feature points 319a. For example, if the system 101 has received a first linear feature point 319a associated with a first time instance (or a first time stamp) and a second linear feature point 319a associated with a second time instance (or a second time stamp) such that the first time instance is prior in time to the second time instance, then the system 101 may assign a first matched distance associated with the first linear feature point 319a with a less weightage in comparison to a second matched distance associated with the second linear feature point 319a. Further, the system 101 may be configured to compute the weighted median of the matched distances associated with the plurality of linear feature points 319a, based on the weight assigned to each matched distance associated with each of the plurality of linear feature points 319a. Similarly, the system 101 may be configured to compute the respective feature matched distance for each of the one or more linear feature clusters 351, 353, and 355.

In an example embodiment, to determine the second set of feature matched distances, the system 101 may be configured to compute the respective feature matched distance for each of the one or more linear feature clusters 357, 361, 363, and 371 associated with the sub link 307b. For example, to compute the feature matched distance for the 357, the system 101 may be configured to compute the weighted median of the matched distances associated with the plurality of linear feature points 321a and 325a. Similarly, the system 101 may be configured to calculate the respective feature matched distance for each of the one or more linear feature clusters 361, 363, and 371. Once the set of feature matched distances for each of the plurality of sub links 307a and 307b is determined, the system 101 may be configured to determine the plurality of linear feature groups 373, 375, 377, and 379. For instance, the system 101 may determine the plurality of linear feature groups 373, 375, 377, and 379, based on the at least one set of feature matched distances and the determined linear feature clusters 349, 351, 353, 355, 357, 361, 363, and 371. For instance, the at least one set of feature matched distances may include the first set of feature matched distances associated with the sub link 307a and the second set of featured matched distances associated with the sub link 307b. For example, the system 101 may determine the plurality of linear feature groups 373, 375, 377, and 379, based on the determined linear feature clusters 349, 351, 353, 355, 357, 361, 363, and 371, the first set of feature matched distances and the second set of feature matched distances, as explained in the detailed description of FIG. 3E.

FIG. 3E illustrates a flowchart 300e for determining the plurality of linear feature groups 373, 375, 377, and 379 based on the determined linear feature clusters 349, 351, 353, 355, 357, 361, 363, and 371, the first set of feature matched distances and the second set of feature matched distances, in accordance with one or more example embodiments. FIG. 3E is explained in conjunction with FIG. 3D. Starting at block 381, the system 101 may compute a difference between a first feature matched distance in the first set of feature matched distances and a second feature matched distance in the second set of feature matched distances. For instance, the system 101 may compute a difference between the feature matched distance associated with the linear feature cluster 349 and the feature matched distance associated with the linear feature cluster 357.

At block 383, the system 101 may be configured to check if the computed difference is less than a threshold difference value. For example, the system 101 may check if the difference between the feature matched distance associated with the linear feature cluster 349 and the feature matched distance associated with the linear feature cluster 357 is less than the threshold difference value. For instance, the threshold difference value may be a value (e.g., ‘0.5’) that is predetermined based on experimentation and the like.

When the computed difference is less than the threshold difference value, the system 101 may continue with block 385. At block 385, the system 101 may be configured to group, into a linear feature group, a first linear feature cluster associated with the first feature matched distance and a second linear feature cluster associated with the second feature matched distance. For instance, the system 101 may group the linear feature cluster 349 and the linear feature 357 into the linear feature group 373. In other words, the system 101 may group, into the linear feature group 373, the linear feature cluster 349 (the first linear feature cluster 349) and the linear feature cluster 357 (the second linear feature cluster 357), if the first feature matched distance of the linear feature cluster 349 is substantially matching the second feature matched distance of the linear feature cluster 357.

When the computed difference is not less than the threshold difference value, the system 101 may continue with block 387. At block 387, the system 101 may be configured to check if the second set of feature matched distances is empty. In other words, at block 387, the system 101 may check if the difference between an element (i.e., the feature matched distance associated with the linear feature cluster 349) in the first set of feature matched distances and each element in the second set of feature matched distances is computed. For instance, the elements in the second set of feature matched distance may include the feature matched distances for the one or more linear feature clusters 357, 361, 363, and 371.

When the second set of feature matched distances is not empty, the system 101 may continue with block 389. At block 389, the system 101 may be configured to select a next feature matched distance in the second set of feature matched distances. For example, the system 101 may select the feature matched distance associated with the linear feature cluster 361.

Once the feature matched distance associated with the linear feature cluster 361 is selected, the system 101 may continue with block 381. At block 381, the system 101 may compute a difference between the first feature matched distance (e.g., the feature matched distance associated with the linear feature cluster 349) and the next second feature matched distance (e.g., the feature matched distance associated with the linear feature cluster 361).

At block 383, the system 101 may check if the difference between the first feature matched distance and the next second feature matched distance is less than the threshold difference value. If the difference between the first feature matched distance and the next second feature matched distance is not less than the threshold difference value, the system 101 may continue with block 387. At block 387, the system 101 may check if the second set of feature matched distances is empty. If the second set of feature matched distances is not empty, the system 101 may continue with block 389. At block 389, the system 101 may be configured to select a next second feature matched distance in the second set of feature matched distances. For instance, the system 101 may select the feature matched distance associated with the linear feature cluster 363. Once the feature matched distance associated with the linear feature cluster 363 is selected, the system 101 may continue with block 381.

In this way, the system 101 may iteratively execute one or more blocks of the blocks 381, 383, 385, 387, 389 to group the linear feature cluster 349 associated with the sub link 307a with at least one linear feature cluster (e.g. the linear feature cluster 357) associated with the sub link 307b, if the difference between the feature matched distance associated with the linear feature cluster 349 and the feature matched distance associated with the at least one linear feature cluster of the sub link 307b is less than the threshold difference value.

When the second set of feature matched distances is empty, the system 101 may continue block 391. At block 391, the system 101 may configured to check if the first set of feature matched distances is empty. If the first set of feature matched distance is not empty, the system 101 may continue with step 393. At step 393, the system 101 may be configured to select a next first feature matched distance in the first set of feature matched distances. For instance, the system 101 may select the feature matched distance associated with the linear feature cluster 351.

Once the feature matched distance associated with the linear feature cluster 351 is selected, the system 101 may iteratively execute one or more blocks of the blocks 381, 383, 385, 387, 389 to group the linear feature cluster 351 associated with the sub link 307a with at least one linear feature cluster (e.g. the linear feature cluster 361) associated with the sub link 307b, if the difference between the feature matched distance associated with the linear feature cluster 351 and the feature matched distance associated with the at least one linear feature cluster of the sub link 307b is less than the threshold difference value.

In this way, the system 101 may iteratively execute the flowchart 300e, to group at least one first linear feature cluster associated with the sub link 307a with at least one second linear feature cluster associated with the sub link 307, if the difference between the feature matched distance associated with the at least one first linear feature cluster of the sub link 307a and the feature matched distance associated with the at least one second linear feature cluster of the sub link 307b is less than the threshold difference value.

Referring to FIG. 3D, for example, the system 101 may group the linear feature cluster 349 and the linear feature cluster 357 into the linear feature group 373, if the difference between the feature matched distance associated with the linear feature cluster 349 and the feature matched distance associated with the linear feature cluster 357 is less than the threshold value. Similarly, the system 101 may group the linear feature cluster 351 and the linear feature cluster 361 into the linear feature group 375; the linear feature cluster 353 and the linear feature cluster 363 into the linear feature group 377; and the linear feature cluster 341 and the linear feature cluster 371 into the linear feature group 379.

Once the plurality of linear feature groups 373, 375, 377, and 379 is determined, the system 101 may be configured to generate the linear feature data. For example, the system 101 may generate the linear feature data based on the determined plurality of linear feature groups 373, 375, 377, and 379. In an example embodiment, to generate the linear feature data, the system 101 may be configured to fill one or more gaps in each of the plurality of linear feature groups 373, 375, 377, and 379. For instance, to accurately represent the linear feature 311, the system 101 may fill a gap between the linear feature cluster 349 (or the linear feature detection data 319) and the linear feature cluster 357 (or the linear feature detection data 321); and a gap between the linear feature detection data 321 and the linear feature detection data 325. For instance, to accurately represent the linear feature 313, the system 101 may fill a gap between the linear feature detection data 327 and the linear feature detection data 329. For instance, to accurately represent the linear feature 315, the system 101 may fill a gap between the linear feature detection data 335 and the linear feature detection data 339. For instance, to accurately represent the linear feature 317, the system 101 may fill a gap between the linear feature detection data 341 and the linear feature detection data 343.

In this way, the system 101 may generate, based on the determined plurality of groups 373, 375, 377, and 379, the linear feature data representing the linear features 311, 313, 315, and 317 such that the unwanted conditions are avoided. In an example embodiment, after generating the linear feature data, the system 101 may be configured to update the map data associated with the mapping platform 103 to include the generated linear feature data. In an example embodiment, the system 101 may be further configured to provide, using one or more of the generated linear feature data and the updated map data, one or more navigation functions for a vehicle. Some non-limiting examples of the navigation functions includes providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

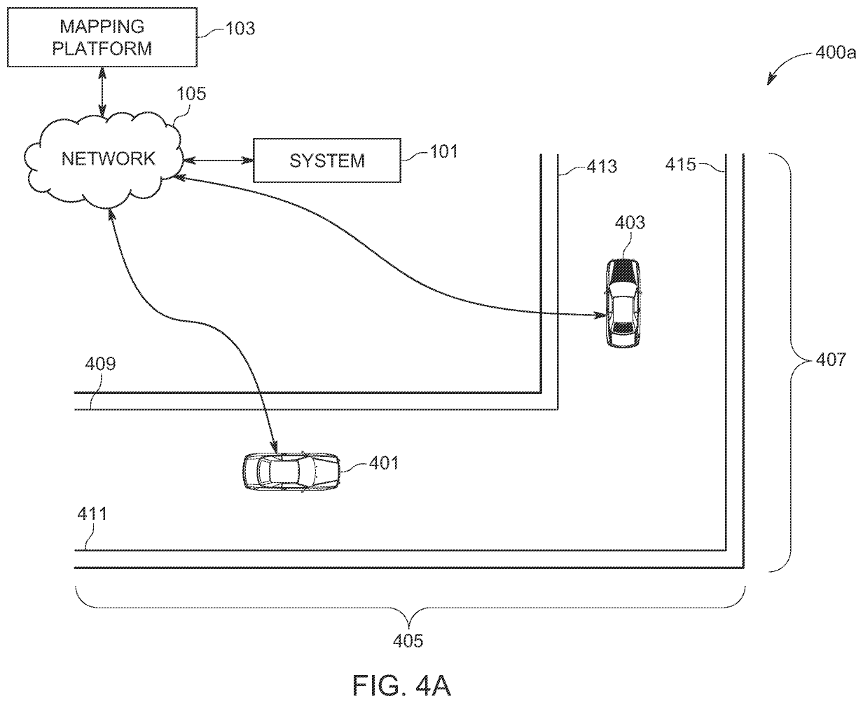

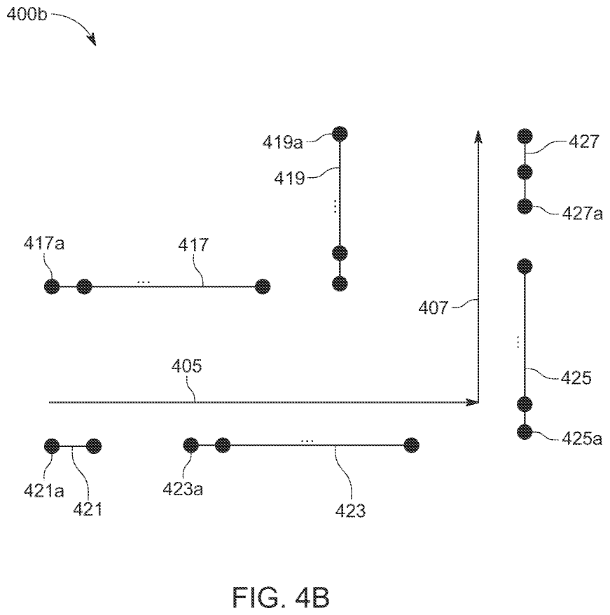

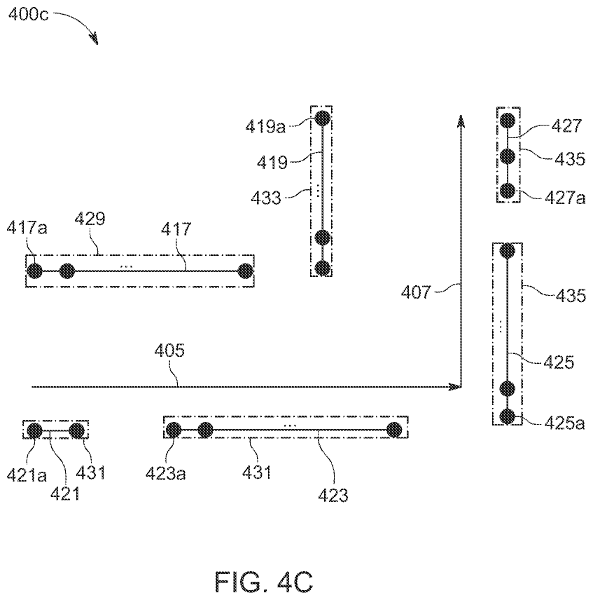

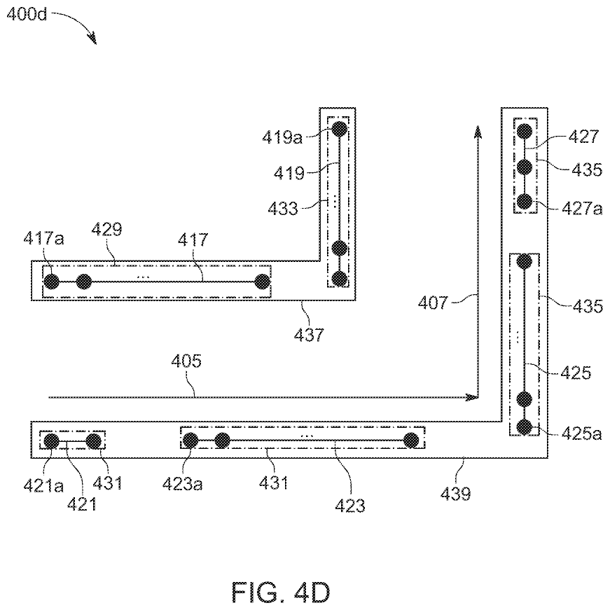

For purpose of explanation, in FIG. 3A-3D, the system 101 configured to generate the linear feature data for the other-than straight road segment (i.e., the link 307) is considered. However, the system 101 may also be configured to generate the linear feature data for one or more straight road segments. For instance, the system 101 may generate the linear feature data for the one or more straight road segments, as explained in the detailed description of FIG. 4A-4D.

FIG. 4A illustrates a second working environment 400a of the system 101 for generating the linear feature data, in accordance with one or more example embodiments. As illustrated in FIG. 4A, the second working environment 400a includes the system 101, the mapping platform 103, the network 105, a plurality of vehicles 401 and 403, a first link 405, a second link 407 adjacent to the first link 405, linear features 409 and 411 associated with the first link 405, linear features 413 and 415 associated with the second link 407. Each of the plurality of vehicles 401 and 403 may correspond to any one of: the autonomous vehicle, the semi-autonomous vehicle, or the manual vehicle.

As used herein, the ‘link’ (e.g., the link 405 and the link 407) may be a road segment between two nodes. Each of the links 405 and 407 may be the freeway, the expressway, the highway, or the like. The link 405 may be associated with the linear feature 409 and 411. For instance, each of the linear features 409 and 411 may correspond to a border of the link 405 (and/or a boarder of a lane of the link 405), where the border may be represented by one or more of: the lane markings, the guardrails, the road curbs, the road medians, the road barriers, or the like. The link 407 may be associated with the linear feature 413 and 415. For instance, each of the linear features 413 and 415 may correspond to a border of the link 405 (and/or a boarder of a lane of the link 405), where the border may be represented by one or more of: the lane markings, the guardrails, the road curbs, the road medians, the road barriers, or the like.

Some embodiments are based on the recognition that the linear features 409, 411, 413, and 415 may be used in vehicle navigation for assisting the vehicles 401 and/or 403. For instance, the linear features 409, 411, 413, and 415 may be used in lane maintenance application and the like. To this end, in some embodiments, the vehicles 401 and 403 may be equipped with various sensors to capture the linear features 409, 411, 413, and 415. For instance, the sensors may include the radar system, the LiDAR system, the global positioning sensor for gathering location data (e.g., GPS), the image sensors, the temporal information sensors, the orientation sensors augmented with the height sensors, the tilt sensors, and the like. In some example embodiments, the sensors may collect the linear features 409, 411, 413, and 415 as linear feature points, leading to linear feature detection data. In these embodiments, sensor data obtained from the sensors include the linear feature detection data, among other things. For instance, each linear feature point in the linear feature detection data may represent image data corresponding to at least one of the linear features 409, 411, 413, and 415.

However, in most of cases, the sensors may fail to continuously capture the linear features 409, 411, 413, and 415, leading to discontinuities in the linear feature detection data. For instance, the sensors may fail to continuously capture the linear features 409, 411, 413, and 415, due to occlusions (caused by interference of other vehicles), noise in the sensors, or other defects in the sensors. In other words, the discontinuities in the linear feature detection data may occur when the sensors fail to completely capture the linear features 409, 411, 413, and 415. As a result, a gap may be formed between any two consecutive linear feature points in the linear feature detection data. As used herein, the gap between any two consecutive linear feature points may be indicative of a distance of discontinuity. Hereinafter, the ‘discontinuities in the linear feature detection data’ and ‘discontinuous detection data’ may be interchangeably used to mean the same.

Thereby, the linear feature detection data extracted from the sensor data may not be accurate to provide the vehicle navigation when the linear feature detection data corresponds to the discontinuous detection data. Furthermore, if the discontinuous detection data is used in the vehicle navigation, a vehicle may end-up with unwanted conditions such as entering a wrong lane, road accidents, traffic congestions, vehicle efficiency reduction, environmental pollutions, and the like. To this end, when the linear feature detection data corresponds to the discontinuous detection data, the system 101 is provided for generating the linear feature data such that the unwanted conditions are avoided. Further, to generate the linear feature data, the system 101 may be configured as explained in the detailed description of FIG. 4B-FIG. 4D.

FIG. 4B illustrates a schematic diagram 400b for determining, from the sensor data, the linear feature detection data associated with the at least one link 405 and 407, in accordance with one or more example embodiments. FIG. 4B is explained in conjunction with FIG. 4A. As illustrated in FIG. 4B, the schematic diagram 400b may include linear feature detection data 417, 419, 421, 423, 425, and 427, the at least one link 405 and 407. In an embodiment, the system 101 may be configured to obtain, from the sensors, the sensor data. For instance, the reception module 201a may obtain the sensor data from the sensors. In an example embodiment, the sensor data may include the linear feature detection data 417, 419, 421, 423, 425, and 427. The linear feature detection data 417 may correspond to the linear feature 409. The linear feature detection data 419 may correspond to the linear feature 413. The linear feature detection data 421 and 423 may correspond to the linear feature 411. The linear feature detection data 425 and 427 may correspond to the linear feature 415. In an example embodiment, each of the linear feature detection data 417, 419, 421, 423, 425, and 427 may include a plurality of linear feature points. For instance, the linear feature detection data 417 may include a plurality of linear feature points 417a, where each linear point 417a may be data (e.g., image data) indicating the linear feature 409. Similarly, the linear feature detection data 491 may include a plurality of linear feature points 419a, the linear feature detection data 421 may include a plurality of linear feature points 421a, the linear feature detection data 423 may include a plurality of linear feature points 423a, the linear feature detection data 425 may include a plurality of linear feature points 425a, and the linear feature detection data 427 may include a plurality of linear feature points 427a.

In an example embodiment, the sensor data may further include time stamp data, vehicle location data, and lateral position data along with the linear feature detection data 417, 419, 421, 423, 425, and 427. The time stamp data may include the time stamp for each linear feature point of the linear feature detection data 417, 419, 421, 423, 425, and 427. As used herein, the time stamp may indicate a time instance at which a particular linear feature point was recorded by the sensors. The vehicle location data may include the vehicle location for each linear feature point of the linear feature detection data 417, 419, 421, 423, 425, and 427. As used herein, the vehicle location may indicate a location of a vehicle at where a particular linear feature point was recorded by the sensors. The lateral position data may include a lateral position distance for each linear feature point of the linear feature detection data 417, 419, 421, 423, 425, and 427. As used herein, the lateral position distance may be a distance from the vehicle to a particular linear feature point recorded by the sensors. In some embodiments, the lateral position distance may be associated with a sign (e.g., a positive sign or a negative sign). For instance, the lateral position distance with the positive sign may indicate that the particular linear feature point is located on right side with respect to a direction of travel of the vehicle. Conversely, the lateral position distance with the negative sign may indicate that the particular linear feature point is located on left side with respect to a direction of travel of the vehicle.

For example, once the system 101 receives the sensor data (e.g., the linear feature points 417a, the time stamp data associated with the linear feature points 417a, the vehicle location data associated with the linear feature points 417a, and the lateral position data associated with the linear feature points 417a), the system 101 may be configured to identify, using the map data, the first link 405 (also referred to as a first sub link 405) based on the sensor data. For instance, the linear feature detection module 201b of the system 101 may map-match the sensor data (specifically, the vehicle location data) with the map data to identify the first link 405. In various embodiments, the first link 405 may be identified as at least one vector line. In some example embodiments, after identifying the first link 405, the system 101 may be configured to check if the first link 405 is a straight road segment or not. In an example embodiment, the system 101 may check if the first link 405 is the straight road segment or not, based on a plurality of nodes associated with the first link 405. For instance, if the plurality of nodes associated with the first link 405 does not include at least one shape location, then the system 101 may identify the first link 405 as the straight road segment.

In response to identifying the first link 405 as the straight road segment, the system 101 may be configured to identify, using the map data, the second link 407 (also referred to as a second sub link 407) adjacent to the first link 405. In other words, the system 101 may identify, in a direction of travel associated with the first link 405, at least one second link (e.g., the second link 407) connected to the first link 405, based on the map data. For instance, the second link 407 may be (i) a link that is connected to the first link 305 and/or (ii) a link that is within a threshold distance from the first link 405. Accordingly, the system 101 may be configured to identify, using the sensor data and the map data, the at least one link comprising the first link 405 and the second link 407.

Once the first link 405 and the second link 407 are identified, the system 101 may be configured to determine, from the sensor data, the linear feature detection data 417 associated with the first link 405 by arranging the plurality of linear feature points 417a with respect to the first link 405, based on the vehicle location data associated with the linear feature points 417a, the time stamp data associated with the linear feature points 417a, and the lateral position data associated with the linear feature points 417a. For instance, the linear feature detection module 201b may be configured to determine, from the sensor data, the linear feature detection data 417 associated with the first link 405.

Similarly, the system 101 may determine, from the sensor data, the linear feature detection data 421 and 423 associated with the first link 405 and the linear feature detection data 419, 425, and 427 associated with the second link 407. Once the linear feature detection data 417, 419, 421, 423, 425, and 427 are determined, the system 101 may be further configured to determine a status of the linear feature detection data 417, 419, 421, 423, 425, and 427 associated with the at least one link 405 and 407. For instance, the linear feature detection module 201b may be configured to determine the status of the linear feature detection data 417, 419, 421, 423, 425, and 427. In an embodiment, the system 101 may determine the status of the linear feature detection data 417, 419, 421, 423, 425, and 427 as at least one of the discontinuous detection data or continuous detection data. For instance, the system 101 may determine the status as the discontinuous detection data, if a distance between any two consecutive linear feature points of the linear feature data 417, 419, 421, 423, 425, and 427 is greater than a threshold distance. In other words, the system 101 may determine the status as the discontinuous detection data, if a distance between any two consecutive linear feature detection data of the linear feature detection data 417, 419, 421, 423, 425, and 427 is greater than the threshold distance. For instance, the system 101 may determine the status as the discontinuous detection data, if a distance between the linear feature detection data 417 (or the linear feature point 417a) and the linear feature detection data 419 (or the linear feature point 419a) is greater than the threshold distance.

Alternatively, the system 101 may determine the status as the continuous detection data, if distances between all consecutive linear feature detection data of the linear feature detection data 417, 419, 421, 423, 425, and 427 are less than the threshold distance. For instance, if the status is determined as the continuous detection data, the system 101 may use the linear feature detection data 417, 419, 421, 423, 425, and 427 as the linear feature data to aid a vehicle in the vehicle navigation. Alternatively, in response to determining the status as the discontinuous detection data, the system 101 may be configured to determine, using the map data, one or more linear feature clusters respectively for each of the first link 405 and the second link 407, based on the linear feature detection data 417, 419, 421, 423, 425, and 427. For instance, the system 101 may determine the one or more linear feature clusters respectively for each of the first link 405 and the second link 407 as explained in the detailed description of FIG. 4C.

FIG. 4C illustrates a schematic diagram 400c for determining the one or more linear feature clusters for each of the first link 405 and the second link 407, in accordance with one or more example embodiments. FIG. 4C is explained in conjunction with FIG. 4B. As illustrated in FIG. 4C, the schematic diagram 400c may include the linear feature detection data 417, 419, 421, 423, 425, and 427, the first link 405, the second link 407, one or more linear feature clusters 429 and 431 associated with the first link 405, and one or more linear feature clusters 433 and 435 associated with the second link 407. According to an embodiment, the system 101 may be configured to determine, based on the map data and the linear feature detection data 417, 419, 421, 423, 425, and 427, the one or more linear feature clusters 429 and 431 for the first link 405 and the one or more linear feature clusters 433 and 435 for the second link 407. For instance, the linear feature cluster determination module 201c may be configured to determine, based on the map data and the linear feature detection data 417, 419, 421, 423, 425, and 427, the one or more linear feature clusters 429 and 431 for the first link 405 and the one or more linear feature clusters 433 and 435 for the second link 407.

In an example embodiment, to determine the one or more linear feature clusters 429 and 431 for the first link 405, the system 101 may be configured to identify, from the linear feature detection data 417, 419, 421, 423, 425, and 427, linear feature detection data associated with the first link 405. For instance, the linear feature detection data 417, 421, and 423 may be identified as the linear feature detection data associated with the first link 405.

Once the linear feature detection data 417, 421, and 423 (or the plurality of linear feature points 417a, 421a, and 423a) associated with the first link 405 are identified, the system 101 may be configured to determine, using the map data, the matched distance for each linear feature point of each of the linear feature detection data 417, 421, and 423. As used herein, the matched distance may be a distance between a link (e.g., the first link 405) and a particular linear feature point. Accordingly, in an example embodiment, the system 101 may determine the matched distance between the first link 405 and each linear feature point of each of the linear feature detection data 417, 421, 423. In other words, the system 101 may calculate the matched distances between the first link 405 and the plurality of linear feature points 417a, the matched distances between the first link 405 and the plurality of linear feature points 421a, and the matched distances between the first link 405 and the plurality of linear feature points 423a.

Once the matched distance for each linear feature point of each of the linear feature detection data 417, 421, and 423 is determined, the system 101 may be configured to determine the linear feature cluster 429 for the first link 405, based on the clustering criteria. According to the clustering criteria, the system 101 may determine one linear feature cluster by clustering one or more linear feature points of the plurality of linear feature points 417a, 421a, and 423a into one linear feature cluster, if the matched distance associated with each of the one or more linear feature points is identical (or similar). So accordingly, for example, the system 101 may cluster the plurality of linear feature points 417a into the linear feature cluster 429, if the matched distances associated with each of the plurality of linear feature points 417a is identical. Similarly, the system 101 may cluster the plurality of points 421a and the plurality of points 423a into the linear feature cluster 431 if the matched distances associated with each of the plurality of linear feature points 421a and the matched distances associated with each of the plurality of linear feature points 423a are identical. To this end, the system 101 may determine the one or more linear feature clusters 429 and 431, where each linear feature cluster includes one or more linear feature points with similar matched distances.

Once the one or more linear feature clusters 429 and 431 are generated for the first link 405, the system 101 may be configured to identify the second link 407 is adjacent (or connected) to the first link 405. Further, the system 101 may be configured to identify, from the linear feature detection data 417, 419, 421, 423, 425, and 427, linear feature detection data associated with the second link 407. For instance, the linear feature detection data 419, 425, and 427 may be identified as the linear feature detection data associated with the second link 407. Once the linear feature detection data 419, 425, and 427 (or the plurality of linear feature points 419a, 425a, and 427a) associated with the second link 407 are identified, the system 101 may be configured to determine, using the map data, the matched distance for each linear feature point of each of the linear feature detection data 419, 425, and 427. In an example embodiment, the system 101 may determine the matched distance between the second link 407 and each linear feature point of each of the linear feature detection data 419, 425, and 435.

Once the matched distance for each linear feature point of each of the linear feature detection data 419, 425, and 435 is determined, the system 101 may be configured to cluster, based on the clustering criteria, the linear feature detection data 419, 425, and 427 associated with the second link 407 into the one or more linear feature clusters 433 and 435. For example, the system 101 may cluster the plurality of linear feature points 419a into the linear feature cluster 433, if the matched distance associated with each of the plurality of linear feature points 419a is identical. Similarly, the system 101 may cluster the plurality of linear feature points 425a and the plurality of linear feature points 427a into the linear feature cluster 435. To this end, the system 101 may determine the one or more linear feature clusters 433 and 435 for the second link 407.

In this way, the system 101 may be configured to determine the one or more linear feature clusters 429 and 431 for the first link 405 and the one or more linear feature clusters 433 and 435 for the second link 407. Once the linear feature clusters 429, 431, 433, and 435 are generated, the system 101 may be configured to determine a plurality of linear feature groups for the at least one link 405 and 407, based on the determined linear feature clusters 429, 431, 433, and 435. In some example embodiments, before determining the plurality of linear feature groups, the system 101 may be configured to check if the linear feature detection data 417, 419, 421, 423, 425, and 427 include the diagonal detection data and/or the lateral position error data. If the linear feature detection data 417, 419, 421, 423, 425, and 427 include the diagonal data and/or the lateral position error data, the system 101 may be configured to remove from the linear feature detection data 417, 419, 421, 423, 425, and 427, the diagonal detection data and/or the lateral position error data. If the linear feature detection data 417, 419, 421, 423, 425, and 427 do not include the diagonal detection data and/or the lateral position error data, the system 101 may be configured to determine the plurality of linear feature groups for the at least one link 405 and 407, based on the determined linear feature clusters 429, 431, 433, and 435. For instance, the system 101 may determine the plurality of linear feature groups, based on the determined linear feature clusters 429, 431, 433, and 435 as explained in the detailed description of FIG. 4D.

FIG. 4D illustrates a schematic diagram 400d for determining the plurality of groups, based on the determined linear feature clusters 429, 431, 433, and 435, in accordance with one or more example embodiments. FIG. 4D is explained in conjunction with FIG. 4C. As illustrated in the FIG. 4D, the schematic diagram 400d may include the linear feature detection data 417, 419, 421, 423, 425, and 427, the first link 405, the second link 407, the linear feature clusters 429, 431, 433, and 435, a plurality of linear feature groups 437 and 439. According to an embodiment, the system 101 may be configured to determine the plurality of linear feature groups 437 and 439 for the at least one link 405 and 407, based on the determined linear feature clusters 429, 431, 433, and 435. For instance, the linear feature group determination module 201d may be configured to determine the plurality of linear feature groups 437 and 439 for the at least one link 405 and 407, based on the determined linear feature clusters 429, 431, 433, and 435.

In an example embodiment, to determine the plurality of linear feature groups 437 and 439, the system 101 may be configured to determine a set of feature matched distances for each of the first link 405 and the second link 407, based on the determined linear feature clusters 429, 431, 433, and 435. For instance, the system 101 may determine a first set of feature matched distances for the first link 405 and a second set of feature matched distances for the second link 407.

In an example embodiment, to determine the first set of feature matched distances, the system 101 may be configured to compute a feature matched distance for each of the one or more linear feature clusters 429 and 431 associated with the first link 405. For example, to compute the feature matched distance for the linear feature cluster 429, the system 101 may be configured to compute the weighted median of the matched distances associated with the plurality of linear feature points 417a of the linear feature cluster 429. In an example embodiment, to compute the weighted median of the matched distances associated with the plurality of linear feature points 417a, the system 101 may be configured to assign a weight for each matched distance associated with each of the plurality of linear feature points 417a, based on a length of the linear feature cluster 429 and/or the time stamp associated with each of the plurality of linear feature points 417a. Further, the system 101 may be configured to compute the weighted median of the matched distances associated with the plurality of linear feature points 417a, based on the weight assigned to each matched distance associated with each of the plurality of linear feature points 417a. Similarly, the system 101 may be configured to compute the feature matched distance for the linear feature cluster 431.

In an example embodiment, to determine the second set of feature matched distances, the system 101 may be configured to compute the feature matched distance for each of the one or more linear feature clusters 433 and 435. For example, to compute the feature matched distance for the linear feature cluster 433, the system 101 may compute the weighted median of the matched distances associated with the plurality of linear feature points 419a of the linear feature cluster 433. Similarly, the system 101 may compute the feature matched distance for the linear feature cluster 435. Once the set of feature matched distances for each of the first link 405 and the second link 407 is determined, the system 101 may be configured to determine the plurality of linear feature groups 437 and 439 for the at least one link 405 and 407. For instance, the system 101 may determine the plurality of linear feature groups 437 and 439, based on the determined linear feature clusters 429, 431, 433, and 435, the first set of feature matched distances associated with the first link 405 and the second set of featured matched distances associated with the second link 407.

In an example embodiment, to determine the linear feature group 437, the system 101 may be configured to compute a first difference between the feature matched distance associated with the linear feature cluster 429 and the feature matched distance associated with the linear feature cluster 433. Further, the system 101 may be configured to check if the first difference is less than the threshold difference value. If the first difference is less than the threshold difference value, the system 101 may group the linear feature cluster 429 of the first link 405 with the linear feature cluster 433 of the second link 407 to determine the linear feature group 437. Furthermore, the system 101 may be configured to compute a second difference between the feature matched distance associated with the linear feature cluster 429 and the feature matched distance associated with the linear feature cluster 435. If the second difference is less than the threshold difference value, the system 101 may group the linear feature cluster 429 of the first link 405, the linear feature cluster 433 of the second link 407, and the linear feature cluster 435 of the second link 407 to determine the linear feature group 437. If the second difference is not less than the threshold difference value, the system 101 may select a next linear feature cluster associated with the first link 405. For instance, the system 101 may select the linear feature cluster 431 as the next linear feature cluster.

Once the linear feature cluster 431 is selected, the system 101 may be configured to compute a third difference between the feature matched distance associated with the linear feature cluster 431 and the feature matched distance associated with the linear feature cluster 433. Further, the system 101 may be configured to check if the third difference is less than the threshold difference value. If the third difference value is not less than the threshold difference value, the system 101 may select a next linear feature cluster associated with the second link 407. For instance, the system 101 may select the linear feature cluster 435 as the next linear feature cluster.

Once the linear feature cluster 435 is selected, the system 101 may be configured to compute a fourth difference between the feature matched distance associated with the linear feature cluster 431 and the feature matched distance associated with the linear feature cluster 435. Further, the system 101 may be configured to check if the fourth difference is less than the threshold difference value. If the fourth difference is less than the threshold difference value, the system 101 may group the linear feature cluster 431 of the first link 405 with the linear feature cluster 435 of the second link 407 to determine the linear feature group 439.

In this way, the system 101 may be configured to determine the plurality of linear feature groups 437 and 439 for the at least one link 405 and 407, based on the determined linear feature clusters 429, 431, 433, and 435, the first set of feature matched distances associated with the first link 405 and the second set of featured matched distances associated with the second link 407. In some other embodiments, the system 101 may determine a single set of feature matched distances for the at least one link 405 and 407, rather than determining the set of featured matched for each of the links 405 and 407. In these embodiments, the single set of feature matched distances may include the elements (the feature matched distances of the linear feature clusters 429 and 431) of the first set of feature matched distances and the elements (the feature matched distances of the linear feature clusters 433 and 435) of the second set of feature matched distances. To this end, the system 101 may determine the plurality of linear feature groups 437 and 439 for the at least one link 405 and 407, by computing a difference between each element with each other element in the single set of feature matched distances and comparing the difference with the threshold difference value.

Once the plurality of groups 437 and 439 is determined, the system 101 may be configured to generate the linear feature data. In an example embodiment, to generate the linear feature data, the system 101 may be configured to fill one or more gaps in each of the plurality of groups 437 and 439. For instance, to accurately represent the linear feature 409, the system 101 may fill a gap between the linear feature cluster 429 (or the linear feature detection data 417) and the linear feature cluster 433 (or the linear feature detection data 419). For instance, to accurately represent the linear feature 411, the system 101 may fill a gap between the linear feature detection data 421 and the linear feature detection data 423; and a gap between the linear feature detection data 423 and the linear feature detection data 425. For instance, to accurately represent the linear feature 415, the system 101 may fill a gap between the linear feature detection data 425 and the linear feature detection data 427.

In this way, the system 101 may generate, based on the generated plurality of groups 437 and 439, the linear feature data representing the linear features 409, 411, 413, and 415 such that the unwanted conditions are avoided. In an example embodiment, after generating the linear feature data, the system 101 may be configured to update the map data associated with the mapping platform 103 to include the generated linear feature data. In an example embodiment, the system 101 may be further configured to provide, using one or more of the generated linear feature data and the updated map data, the one or more navigation functions for the vehicle. Some non-limiting examples of the navigation functions includes providing vehicle speed guidance, vehicle speed handling and/or control, providing a route for navigation (e.g., via a user interface), localization, route determination, lane level speed determination, operating the vehicle along a lane level route, route travel time determination, lane maintenance, route guidance, provision of traffic information/data, provision of lane level traffic information/data, vehicle trajectory determination and/or guidance, route and/or maneuver visualization, and/or the like.

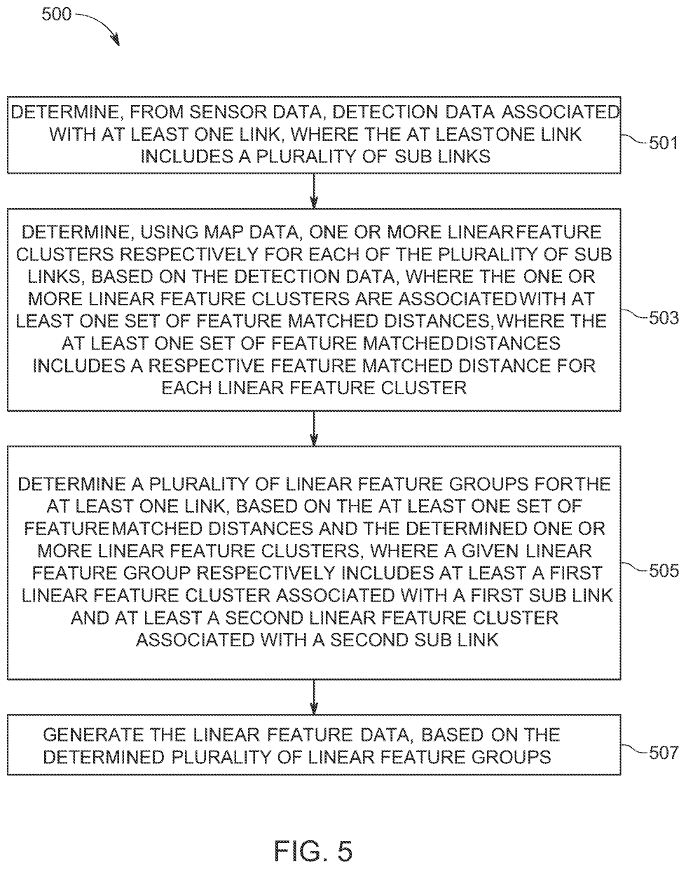

FIG. 5 illustrates a flowchart depicting a method 500 for generating the linear feature data, in accordance with one or more example embodiments. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 203 of the system 101, employing an embodiment of the present invention and executed by the processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow chart support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Starting at block 501, the method 500 may include determining, from the sensor data, the detection data associated with the at least one link. For instance, the linear feature detection module 201b may determine, from the sensor data, the linear feature detection data 319, 321, 323, 325, 327, 329, 331, 333, 335, 337, 339, 341, 343, 345 associated with the at least one link 307 as explained in the detailed description of FIG. 3B. In an example embodiment, the at least one link may include a plurality of sub links.

At block 503, the method 500 may include determining, using the map data, the one or more linear feature clusters respectively for each of the plurality of sub links, based on the detection data. For instance, the linear feature cluster determination module 201c may determine, using the map data and the linear feature detection data 319, 321, 323, 325, 327, 329, 331, 333, 335, 337, 339, 341, 343, 345, the one or more linear feature clusters 349, 351, 353, 355 for the sub link 307a; and the one or more linear feature clusters 357, 359, 361, 363, 365, 367, 369, and 371 for the sub link 307b, as explained in the detailed description of FIG. 3C. Further, the determined linear feature clusters may be associated with at least one set of feature matched distances. For instance, the one or more linear feature clusters 349, 351, 353, 355 are associated with the first set of featured matched distances and the one or more linear feature clusters 357, 359, 361, 363, 365, 367, 369, and 371 are associated with the second set of feature matched distances. For instance, the first set of featured matched distances include the respective featured matched distance for each of the one or more linear feature clusters 349, 351, 353, 355. For instance, the second set of featured matched distances include the respective featured matched distance for each of the one or more linear feature clusters 357, 359, 361, 363, 365, 367, 369, and 371.

At block 505, the method 500 may include determining the plurality of linear feature groups for the at least one link, based on the at least one set of feature matched distances and the determined one or more linear feature clusters. For instance, the linear feature group determination module 201d may determine the plurality of linear feature groups 373, 375, 377, and 379 for the at least one link 307, based on the first set of feature matched distances, the second set of feature matched distances, and the determined linear feature clusters 349, 351, 353, 355, 357, 359, 361, 363, 365, 367, 369, and 371, as explained in the detailed description of FIG. 3D and FIG. 3E. In an example embodiment, a given linear feature group (e.g., the linear feature group 373) respectively includes at least a first liner feature cluster (e.g., the linear feature cluster 349) associated with the first sub link (e.g., the sub link 307a) and at least a second linear feature cluster (e.g., the linear feature cluster 357) associated with the second sub link (e.g., the sub link 307b).

At block 507, the method 500 may include generating the linear feature data, based on the determined plurality of linear feature groups. For instance, the linear feature generating module 201e may generate the linear feature data, based on the determined plurality of linear feature groups 373, 375, 377, and 379, as explained in the detailed description of FIG. 3D.

On implementing the method 500 disclosed herein, the system 101 may be configured to generate the linear feature data, when the detection data is in accurate. Further, the system 101 may be configured to provide, using at least one of the generated linear feature data and/or the updated map data, the one or more navigation functions for the vehicle. Thereby, the system 101 may avoid the unwanted conditions.

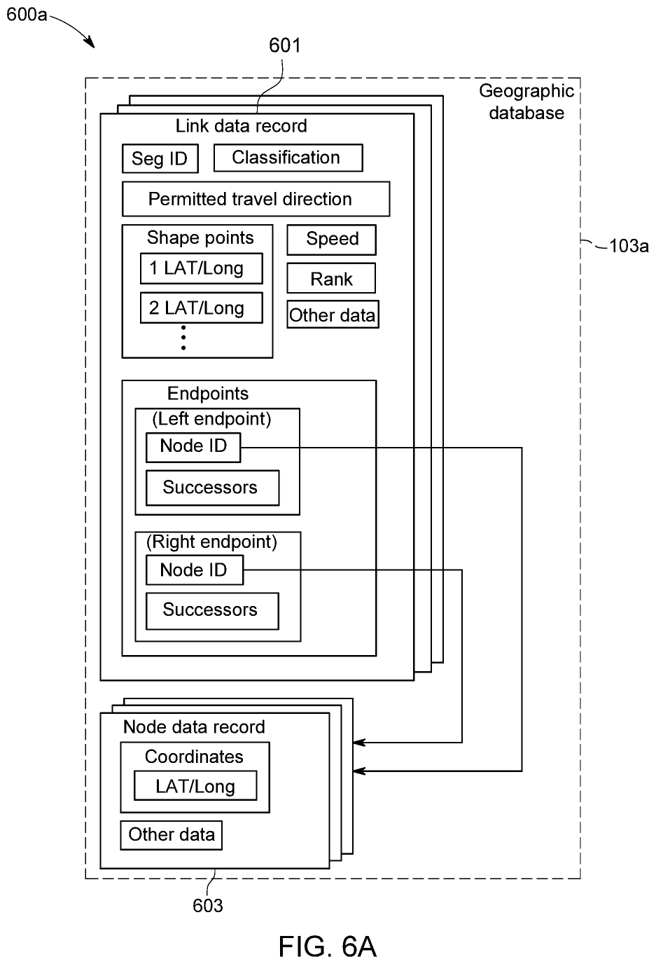

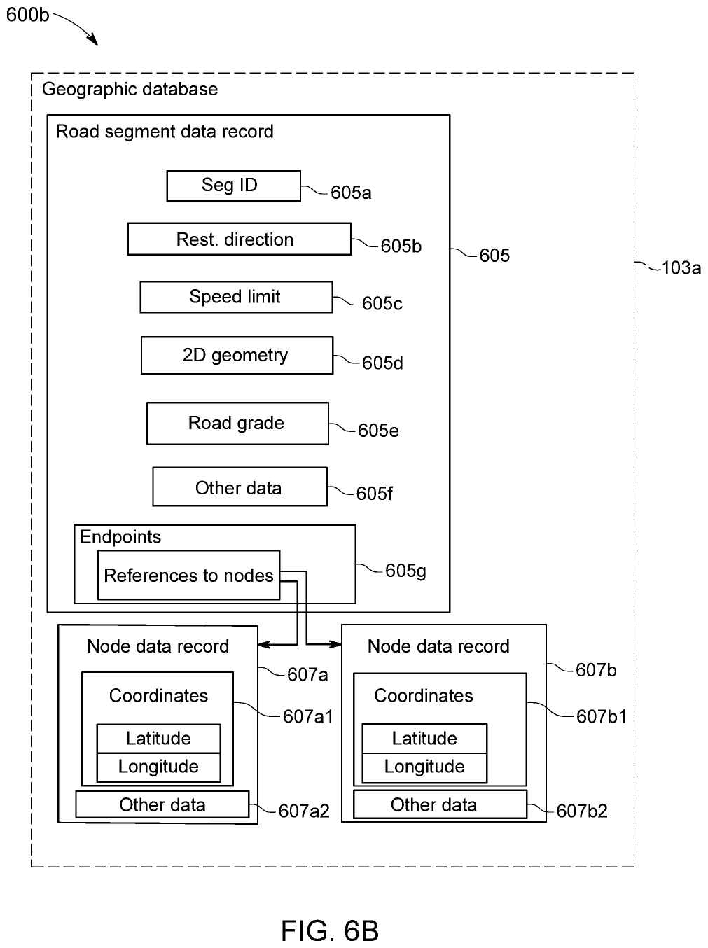

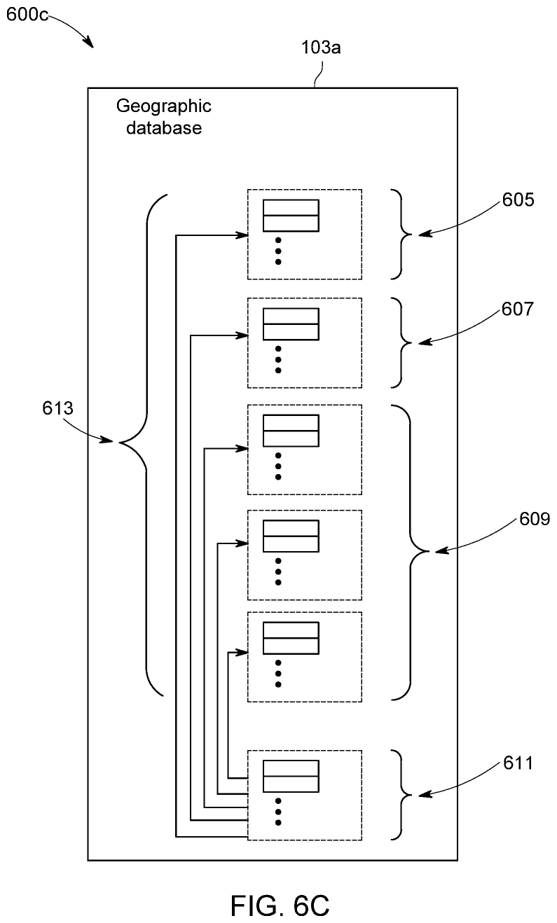

FIG. 6A shows format of map data 600a stored in the map database 103a, in accordance with one or more example embodiments. FIG. 6A shows a link data record 601 that may be used to store data about one or more of the linear features, for example, the linear features 311, 313, 315, and 317 illustrated in FIG. 3A. This link data record 601 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 601 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 601 indicate the position, (e.g., latitude, longitude, and optionally, altitude or elevation) of the selected shape points along the represented link.

Additionally, in the compiled geographic database, such as a copy of the map database 103a that is compiled and provided to a user interface, there may also be a node data record 603 for each node. The node data record 603 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 6B shows another format of map data 600b stored in the map database 103a, in accordance with one or more example embodiments. In FIG. 6B, the map data 600b is stored by specifying a road segment data record 605. The road segment data record 605 is configured to represent data that represents a road network. In FIG. 6B, the map database 103a contains at least one road segment data record 605 (also referred to as “entity” or “entry”) for each road segment in a geographic region.

The map database 103a that represents the geographic region also includes a database record 607 (a node data record 607a and a node data record 607b) (or “entity” or “entry”) for each node associated with the at least one road segment shown by the road segment data record 605. (The terms “nodes” and “segments” represent only one terminology for describing these physical geographic features and other terminology for describing these features is intended to be encompassed within the scope of these concepts). Each of the node data records 607a and 607b may have associated information (such as “attributes”, “fields”, etc.) that allows identification of the road segment(s) that connect to it and/or its geographic position (e.g., its latitude and longitude coordinates).

FIG. 6B shows some of the components of the road segment data record 605 contained in the map database 103a. The road segment data record 605 includes a segment ID 605a by which the data record can be identified in the map database 103a. Each road segment data record 605 has associated with it information (such as “attributes”, “fields”, etc.) that describes features of the represented road segment. The road segment data record 605 may include data 605b that indicate the restrictions, if any, on the direction of vehicular travel permitted on the represented road segment. The road segment data record 605 includes data 605c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 605 may also include data 605d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 605 also includes road grade data 605e that indicate the grade or slope of the road segment. In one embodiment, the road grade data 605e include road grade change points and a corresponding percentage of grade change. Additionally, the road grade data 605e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 605e includes the road grade change points and an actual road grade value for the portion of the road segment after the road grade change point until the next road grade change point or end node. In a further embodiment, the road grade data 605e includes elevation data at the road grade change points and nodes. In an alternative embodiment, the road grade data 605e is an elevation model which may be used to determine the slope of the road segment.

The road segment data record 605 also includes data 605g providing the geographic coordinates (e.g., the latitude and longitude) of the end points of the represented road segment. In one embodiment, the data 605g are references to the node data records 607 that represent the nodes corresponding to the end points of the represented road segment.

The road segment data record 605 may also include or be associated with other data 605f that refer to various other attributes of the represented road segment. The various attributes associated with a road segment may be included in a single road segment record or may be included in more than one type of record which cross-reference each other. For example, the road segment data record 605 may include data identifying the name or names by which the represented road segment is known, the street address ranges along the represented road segment, and so on.

FIG. 6B also shows some of the components of the node data record 607 contained in the map database 103a. Each of the node data records 607 may have associated information (such as “attributes”, “fields”, etc.) that allows identification of the road segment(s) that connect to it and/or it is geographic position (e.g., its latitude and longitude coordinates). For the embodiment shown in FIG. 6B, the node data records 607a and 607b include the latitude and longitude coordinates 607a1 and 607b1 for their nodes. The node data records 607a and 607b may also include other data 607a2 and 607b2 that refer to various other attributes of the nodes. In some embodiments, the node data records 607a and 607b may be associated with linear feature points, which may be the linear features to be generated.

Thus, the overall data stored in the map database 103a may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 103a in the formats shown in FIGS. 6A and 6B may be combined in a suitable manner to provide these three or more layers of information. In some embodiments, there may be lesser or fewer number of layers of data also possible, without deviating from the scope of the present disclosure.

FIG. 6C illustrates a block diagram 600c of the map database 103a, in accordance with one or more example embodiments. The map database 103a stores map data or geographic data 613 in the form of road segments/links, nodes, and one or more associated attributes as discussed above. For instance, the road segments may be represented using the road segment data records 605 and the nodes may be represented using the node data records 607. The attributes may refer to features or data layers associated with the link-node database, such as an HD lane data layer.

In addition, the map data 613 may also include other kinds of data 609. The other kinds of data 609 may represent other kinds of geographic features or anything else. For instance, the other kinds of data 609 may include point of interest data. For example, the point of interest data may include point of interest records comprising a type (e.g., the type of point of interest, such as restaurant, hotel, city hall, police station, historical marker, ATM, golf course, etc.), location of the point of interest, a phone number, hours of operation, etc. The map database 103a also includes indexes 611. The indexes 611 may include various types of indexes that relate the different types of data to each other or that relate to other aspects of the data contained in the geographic database 103a.

The data stored in the map database 103a in the various formats discussed above may help in provide precise data for high-definition mapping applications, autonomous vehicle navigation and guidance, cruise control using ADAS, direction control using accurate vehicle maneuvering and other such services. For example, the system 101 may use the map data 613 along with the sensor data to generate the linear feature data and provide one or more navigation functions for the vehicle such that the unwanted conditions are avoided.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for generating linear feature data, the system comprising:
a memory configured to store computer-executable instructions; and
at least one processor configured to execute the computer-executable instructions to:
determine, from sensor data, detection data associated with at least one link, wherein the at least one link comprises a plurality of sub links;
determine, using map data, one or more linear feature clusters respectively for each of the plurality of sub links, based on the detection data, wherein the one or more linear feature clusters are associated with at least one set of feature matched distances, wherein the at least one set of feature matched distances comprises a respective feature matched distance for each linear feature cluster;
determine a plurality of linear feature groups for the at least one link, based on the at least one set of feature matched distances and the determined one or more linear feature clusters, wherein a given linear feature group respectively comprises at least a first linear feature cluster associated with a first sub link and at least a second linear feature cluster associated with a second sub link; and
generate the linear feature data, based on the determined plurality of linear feature groups.

2. The system of claim 1, wherein determining the plurality of linear feature groups comprises:
group the first linear feature cluster and the second linear feature cluster into a linear feature group, when a difference between (i) the respective feature matched distance of the first linear feature cluster and (ii) the respective feature matches distance of the second linear feature cluster is less than a threshold difference value.

3. The system of claim 1, wherein determining the one or more linear feature clusters for a sub link of the plurality of sub links comprises:
identify, from the detection data, a plurality of linear feature points associated with the sub link;
determine, using the map data, a matched distance for each of the plurality of linear feature points associated with the sub link; and
determine a linear feature cluster for the sub link based on a clustering criteria, wherein the clustering criteria comprises the determined matched distance, and wherein each linear feature cluster of the one or more linear feature clusters of the sub link comprises one or more linear feature point with identical matched distances.

4. The system of claim 3, wherein the feature matched distance associated with the linear feature cluster of the one or more linear feature clusters is a weighted median of the corresponding matched distances associated with the linear feature cluster.

5. The system of claim 1, wherein the at least one processor is further configured to remove diagonal detection data from the detection data, wherein the diagonal detection data comprises at least two linear feature points, and wherein each of the at least two linear feature points is associated with a different linear feature cluster in the one or more linear feature clusters.

6. The system of claim 1, wherein the at least one processor is further configured to update the map data to include the generated linear feature data for the at least one link.

7. The system of claim 1, wherein the at least one processor is further configured to:
determine a status of the detection data associated with the at least one link, wherein the status of the detection data comprises at least one of discontinuous detection data or continuous detection data; and
determine the one or more linear feature clusters respectively for each of the plurality of sub links, in response to determining the status of the detection data is the discontinuous detection data.

8. The system of claim 1, wherein determining the detection data associated with the at least one link comprises:
obtain the sensor data;
map-match, using the map data, the sensor data to identify the at least one link; and
determine, from the sensor data, the detection data associated with the identified at least one link.

9. A method for generating linear feature data, the method comprising:
determining, from sensor data, detection data associated with at least one link, wherein the at least one link comprises a plurality of sub links;
determining, using map data, one or more linear feature clusters respectively for each of the plurality of sub links, based on the detection data, wherein the one or more linear feature clusters are associated with at least one set of feature matched distances, wherein the at least one set of feature matched distances comprises a respective feature matched distance for each linear feature cluster;
determining a plurality of linear feature groups for the at least one link, based on the at least one set of feature matched distances and the determined one or more linear feature clusters, wherein a given linear feature group respectively comprises at least a first linear feature cluster associated with a first sub link and at least a second linear feature cluster associated with a second sub link; and
generating the linear feature data, based on the determined plurality of linear feature groups.

10. The method of claim 9, wherein determining the plurality of linear feature groups comprises:
grouping the first linear feature cluster and the second linear feature cluster into a linear feature group, based on (i) the respective feature matched distance of the first linear feature cluster and (ii) the respective feature matched distance of the second linear feature cluster substantially matching one another.

11. The method of claim 9, wherein determining the one or more linear feature clusters for a sub link of the plurality of sub links comprises:
identifying, from the detection data, a plurality of linear feature points associated with the sub link;
determining, using the map data, a matched distance for each of the plurality of linear feature points associated with the sub link; and
determining a linear feature cluster for the sub link based on a clustering criteria, wherein the clustering criteria comprises the determined matched distance, and wherein each linear feature cluster of the one or more linear feature clusters of the sub link comprises one or more linear feature points with identical matched distances.

12. The method of claim 11, wherein the feature matched distance associated with the linear feature cluster of the one or more linear feature clusters is a weighted median of the corresponding matched distances associated with the linear feature cluster.

13. The method of claim 9, wherein the method further comprising removing diagonal detection data from the detection data, wherein the diagonal detection data comprises at least two linear feature points, and wherein each of the at least two linear feature points is associated with a different linear feature cluster in the one or more linear feature clusters.

14. The method of claim 9, further comprising updating the map data to include the generated linear feature data for the at least one link.

15. A computer program product comprising a non-transitory computer readable medium having stored thereon computer executable instruction which when executed by at least one processor, cause the at least one processor to carry out operations for generating linear feature data, the operations comprising:
determining, from sensor data, detection data associated with at least one link, wherein the at least one link comprises a plurality of sub links;
determining, using map data, one or more linear feature clusters respectively for each of the plurality of sub links, based on the detection data, wherein the one or more linear feature clusters are associated with at least one set of feature matched distances, wherein the at least one set of feature matched distances comprises a respective feature matched distance for each linear feature cluster;
determining a plurality of linear feature groups for the at least one link, based on the at least one set of feature matched distances and the determined one or more linear feature clusters, wherein a given linear feature group respectively comprises at least a first linear feature cluster associated with a first sub link and at least a second linear feature cluster associated with a second sub link; and
generating the linear feature data, based on the determined plurality of linear feature groups.

16. The computer program product of claim 15, wherein for determining the plurality of linear feature groups, the operations further comprise:
grouping the first linear feature cluster and the second linear feature cluster into a linear feature group, when a difference between (i) the respective feature matched distance of the first linear feature cluster and (ii) the respective feature matched distance of the second linear feature cluster is less than a threshold difference value.

17. The computer program product of claim 15, wherein for determining the one or more linear feature clusters for a sub link of the plurality of sub links, the operations further comprise:
identifying, from the detection data, a plurality of linear feature points associated with the sub link;
determining, using the map data, a matched distance for each of the plurality of linear feature points associated with the sub link; and
determining a linear feature cluster for the sub link based on a clustering criteria, wherein the clustering criteria comprises the determined matched distances, and wherein each linear feature cluster of the one or more linear feature clusters of the sub link comprises one or more linear feature points with identical matched distances.

18. The computer program product of claim 17, wherein the feature matched distance associated with the linear feature cluster of the one or more linear feature clusters is a weighted median of the corresponding matched distances associated with the linear feature cluster.

19. The computer program product of claim 15, wherein the operations further comprise removing diagonal detection data from the detection data, wherein the diagonal detection data includes at least two linear feature points, and wherein each of the at least two linear feature points is associated with a different linear feature cluster in the one or more linear feature clusters.

20. The computer program product of claim 15, wherein the operations further comprise updating the map data to include the generated linear feature data for the at least one link.
